(19) United States
(12) Patent Application Publication
(10) Pub. No.: US 2009/0003885 A1
(43) Pub. Date: Jan. 1, 2009

(54) TONER, DEVELOPER, AND IMAGE FORMING APPARATUS

(76) Inventors: Akiyoshi Sabu, Numazu-shi (JP); Akihiro Kotsugai, Numazu-shi (JP); Shinya Nakayama, Numazu-shi (JP); Hiroshi Yamashita, Numazu-shi (JP); Yoshihiro Moriya, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/147,580

(22) Filed: Jun. 27, 2008

(30) Foreign Application Priority Data
Jun. 27, 2007 (JP) 2007-169787
Jun. 27, 2007 (JP) 2007-169788
Aug. 30, 2007 (JP) 2007-224200
Apr. 18, 2008 (JP) 2008-109174

(51) Int. Cl. G03G 15/08; G03G 9/08; G03G 9/087

(52) U.S. Cl. 399/252; 430/109.1; 430/109.4

(57) ABSTRACT

A toner including a colorant and a binder resin is provided. The binder resin includes a first resin comprising a block X comprising a resin comprising a racemic mixture of optically active monomers of a D-form compound and an L-form compound, and a block Y comprising another resin. The weight ratio of the D-form compound to the L-form compound is from 48/52 to 52/48, and the weight ratio of the block Y to the block X is from 1/3 to 3/1. The toner is obtained by dispersing or emulsifying a toner constituent liquid, in which the colorant and the binder resin are dissolved or dispersed in an organic solvent, in an aqueous medium.

### BACKGROUND OF THE INVENTION

1. Field of the Invention

The present invention relates to a toner for use in electrophotography. In addition, the present invention relates to a developer and an image forming apparatus using the toner.

2. Description of the Background

In a typical electrophotographic image forming apparatus, electrostatic recording apparatus, etc., an electric or magnetic latent image is formed into a visible image by a toner. For example, in electrophotography, an electrostatic latent image formed on a photoreceptor is developed with a toner to form a toner image. The toner image is typically transferred onto a recording medium such as paper, and subsequently fixed thereon by application of heat, and the like.

The toner generally includes colored particles containing a binder resin, a colorant, a charge controlling agent, and the like. Toner manufacturing methods are broadly classified into pulverization methods and polymerization methods.

A typical pulverization method includes melt-mixing a thermoplastic resin, a colorant, a charge controlling agent, an offset inhibitor, and the like, to prepare a toner composition; pulverizing the toner composition; and classifying the pulverized particles of the toner composition. The pulverization method is capable of manufacturing a toner having a certain level of desired properties. However, there is a drawback that materials usable for the pulverization method are limited. For example, the toner composition is required to be treatable by economical pulverization and classification apparatuses. Therefore, the toner composition needs to be brittle. However, the brittle toner composition tends to produce particles with a broad particle diameter distribution by pulverization. To produce a copy image having good resolution and gradation, fine particles having a particle diameter of 5 μm or less and coarse particles having a particle diameter of 20 μm or more need to be removed, resulting in low yield. Furthermore, it is difficult to evenly disperse a colorant, a charge controlling agent, and the like agent, in a thermoplastic resin by the pulverization method. Therefore, fluidity, developability, and durability of the resultant toner and image quality of the resultant image may deteriorate.

In attempts to overcome the above-described drawbacks, Unexamined Japanese Patent Application Publication No. (hereinafter “JP-A”) 09-319144 and JP-A 2002-284881 have disclosed a toner manufactured by a dissolution suspension method including: dissolving a resin, previously synthesized by a polymerization reaction, in a solvent, to prepare a resin solution; dispersing the resin solution in an aqueous medium containing a dispersant (optionally with an auxiliary dispersant) such as a surfactant or a water-soluble resin and a dispersion stabilizer such as a particulate inorganic material and a particulate resin, to prepare droplets of the resin solution; and removing the solvent from the droplets by application of heat, reduction in pressure, and the like, to prepare toner particles. It is disclosed therein that the dissolution suspension method is capable of producing uniform-sized particles without classification.

A toner for use in electrophotography is required to have separability, which is an ability to separate from a heating member such as a heat roller in a fixing process, to prevent the occurrence of hot offset problem in which part of melted toner particles are adhered to the surface of the heating member and then re-transferred onto an undesired portion of a recording medium. Japanese Patent No. (hereinafter “JP”) 3640918 also discloses a toner manufactured by a dissolution suspension method, which specifically includes a modified polyester resin so that the resultant toner has good separability.

A typical toner composition includes a binder resin in an amount of 70% or more. Most of the binder resins are made from petroleum resources. However, there are rising concerns of depletion of petroleum resources and global warming caused by emission of carbon dioxide due to heavy consumption of petroleum resources.

For the above reasons, toners including a plant-derived resin as a binder resin have been proposed. Since plants grow up incorporating atmospheric carbon dioxide, use of plant-derived resins may circulate carbon oxide only in the environment. Accordingly, there is a possibility of reducing the concerns of depletion of petroleum resources and global warming at the same time by using plant-derived resins.

For example, JP 2909873 discloses a toner including a polylactic acid as a binder resin. Since polylactic acid includes a greater amount of ester bond than polyester, the polylactic acid may not sufficiently function as a thermoplastic resin when the resultant toner is fixed on a recording medium. Furthermore, the resultant toner may have a high hardness, resulting in poor pulverization efficiency, i.e., poor manufacturability of toner.

JP-A 09-274335 discloses a toner including a polyester resin obtained by subjecting a composition including lactic acid and a terfunctional or higher functional oxycarboxylic acid to a dehydration polycondensation. In particular, the polyester resin is formed from a dehydration polycondensation between hydroxyl groups of the lactic acid and carboxyl groups of the oxycarboxylic acid. Such a polyester resin has a large molecular weight, and therefore the resultant toner may not have a sharp melting point and low-temperature fixability.

JP-A 2001-166537 discloses a toner including a polylactic acid-based biodegradable resin and a terpene-phenol copolymer, to improve thermal properties of the resultant toner. However, the resultant toner may not simultaneously satisfy low-temperature fixability and hot offset resistance.

The above-described toners each are manufactured by the pulverization method, having disadvantages of poor manufacture efficiency due to formation of undesired-sized particles and waste disposal thereof. In addition, the pulverization method consumes a large amount of energy, and therefore reduction of environmental burdens is required.

Polylactic acids are examples of easily available plant-derived resins. As disclosed in JP-A 07-33861 and JP-A 59-96123, a polylactic acid is obtainable from a dehydration condensation of lactic acid or a ring-opening polymerization of lactide of lactic acid. These polylactic acids are applicable to toners manufactured by the dissolution suspension method as disclosed in the above-described references of JP-A 09-319144, JP-A 2002-284881, and JP 3640918. However, a polylactic acid solely consisting of L-lactic acid or D-lactic has an extremely low solubility in organic solvents because of its high crystallinity.

On the other hand, a desired toner cannot be obtained by solely using a polylactic acid, because the molecular weight of polylactic acid is difficult to control and there are only carbon atoms existing between ester bonds in the polylactic acid. By contrast, a desired toner may be obtained when mixing a polylactic acid with another resin. However, polylactic acids have extremely poor compatibility with and dispersibility in typical binder resins such as polyester resins and styrene-acrylic copolymers. Therefore, polylactic acids are generally difficult to apply to toners.

Since crystallization speed of polylactic acid is generally low, it is difficult to control the crystallization state of polylactic acids in a toner manufactured by the dissolution suspension method. More specifically, when a toner includes an amorphous polylactic acid, which has low heat resistance, the toner may have poor offset resistance. In addition, a toner manufactured by the dissolution suspension method may include both a polylactic acid having high crystallinity and that having low crystallinity, in some cases. In this case, the toner particles may be finely pulverized when agitated with carrier particles, because the polylactic acid having low crystallinity has low impact resistance. Consequently, charge of the toner and image density of the resultant image may deteriorate.

### SUMMARY OF THE INVENTION

Accordingly, an object of the present invention is to provide a toner which has good and reliable fixability and thermostable preservability.

Another object of the present invention is to provide a developer and an image forming apparatus which produce high-quality and high-density images.

These and other objects of the present invention, either individually or in combinations thereof, as hereinafter will become more readily apparent can be attained by a toner, comprising:

a colorant; and

a binder resin comprising a first resin comprising:
a block X comprising a resin comprising a racemic mixture of optically active monomers of a D-form compound and an L-form compound; and
a block Y comprising another resin;

wherein a weight ratio of the D-form compound to the L-form compound is from 48/52 to 52/48, and a weight ratio of the block Y to the block X is from 1/3 to 3/1, and

wherein the toner is obtained by dispersing or emulsifying a toner constituent liquid, in which the colorant and the binder resin are dissolved or dispersed in an organic solvent, in an aqueous medium;

and a developer and an image forming apparatus using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of a process cartridge;

FIG. 2 is a schematic view illustrating an embodiment of an image forming apparatus of the present invention;

FIG. 3 is a schematic view illustrating another embodiment of an image forming apparatus of the present invention; and

FIG. 4 is a magnified schematic view illustrating an embodiment the image forming unit illustrated in FIG. 3.

### DETAILED DESCRIPTION OF THE INVENTION

Generally, the toner of the present invention is obtained by dispersing or emulsifying a solution or dispersion (hereinafter “a toner constituent liquid”), in which a colorant and a binder resin (hereinafter collectively “toner constituents”) are dissolved or dispersed in an organic solvent, in an aqueous medium.

The binder resin comprises a first resin (i.e., a block copolymer) comprising a block X comprising a resin comprising a racemic mixture of optically active monomers of a D-form compound and an L-form compound and a block Y comprising another resin, and optionally includes a second resin and other resins, if desired.

Each of the block Y and the second resin may include 2 or more resins.

The racemic mixture of optically active monomers of a D-form compound and an L-form compound refers to an optically inactive substance containing approximately equal amounts (about 50% by weight) of optical enantiomers. The weight ratio (D/L) of the D-form compound to the L-form compound is from 48/52 to 52/48, and preferably from 49/51 to 51/49. When the weight ratio is beyond the above-described range, crystallinity appears in the racemic mixture, and therefore dispersibility of the racemic mixture in the toner constituents may deteriorate.

The weight ratio (Y/X) of the block Y to the block X is preferably from 1/3 to 3/1, and more preferably from 1/2 to 2/1. When Y/X is too small, the toner constituent liquid is difficult to be emulsified or dispersed in an aqueous medium. When Y/X is too large, durability of the resultant toner may be insufficient.

The optically active monomers (i.e., D-form and L-form compounds) preferably have the following formula (1):

R1-C*—H(—OH)(—COOH) (1)

wherein R1 represents an alkyl group having 1 to 10 carbon atoms, such as methyl group, ethyl group, and propyl group.

Specific examples of the compounds having the formula (1) include, but are not limited to, enantiomers of lactic acid, 2-hydroxybutanoic acid, 2-hydroxypentanoic acid, 2-hydroxyhexanoic acid, 2-hydroxyheptanoic acid, 2-hydroxyoctanoic acid, 2-hydroxynonanoic acid, 2-hydroxydecanoic acid, 2-hydroxyundecanoic acid, and 2-hydroxydodecanoic acid. Among these compounds, enantiomers of lactic acids are preferably used.

Specific examples of resins usable for the block Y and the second resin include, but are not limited to, polyester resins (e.g., modified polyester resins, unmodified polyester resins), polymers of styrene or styrene derivatives, styrene copolymers, polymethyl methacrylate, polybutyl methacrylate, polyvinyl chloride, polyvinyl acetate, polyethylene, polypropylene, epoxy resins, epoxy polyol resins, polyurethane, polyamide, polyvinyl butyral, polyacrylic acid resin, rosin, modified rosin, terpene resins, aliphatic or alicyclic hydrocarbon resins, and aromatic petroleum resins. Among these resins, polyester resins (e.g., modified polyester resins, unmodified polyester resins) are preferably used because the resultant toner may have good fixability. The molecular weight, composition of monomers, and the like, of the polyester resin are variable in accordance with the intended use.

The polyester resin is obtainable by a dehydration condensation between a polyol and a polycarboxylic acid.

Specific examples of usable polyols include, but are not limited to, ethylene glycol, propylene glycol, 1,3-butanediol, 1,4-bitanediol, 2,3-bitanediol, diethyleneglycol, triethylene glycol, 1,5-pentanediol, 1,6-hexanediol, neopentyl glycol, 2-ethyl-1,3-hexanediol, hydrogenated bisphenol A, and divalent alcohols obtained by addition of an cyclic ether such as ethylene oxide and propylene oxide with bisphenol A. In order that the resultant polyester resin has cross-linking structure, alcohols having 3 or more valences such as sorbitol, 1,2,3,6-hexanetetrol, 1,4-sorbitan, pentaerythritol, dipentaerythritol, tripentaerythritol, 1,2,4-butanetriol, 1,2,5-pentatriol, glycerol, 2-methylpropanetriol, 2-methyl-1,2,4-butanetriol, trimethylolethane, trimethylolpropane, and 1,3,5-trihydroxybenzene, are preferably used in combination.

Specific examples of usable polycarboxylic acids include, but are not limited to, benzenedicarboxylic acids (e.g., phthalic acid, isophthalic acid, terephthalic acid) and anhydrides thereof, alkyldicarboxylic acids (e.g., succinic acid, adipic acid, sebacic acid, azelaic acid) and anhydrides thereof, unsaturated dibasic acids (e.g., maleic acid, citraconic acid, itaconic acid, alkenylsuccinic acid, fumaric acid, mesaconic acid), anhydrides of unsaturated dibasic acids (e.g., maleic anhydride, citraconic anhydride, itaconic anhydride, alkenylsuccinic anhydride), trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetrakis(methylenecarboxy)methane, 1,2,7,8-octane tetracarboxylic acid, and an hydrides and partial lower alkyl esters thereof.

The second resin may include a polyester resin having a functional group capable of reacting with an active hydrogen group (hereinafter “polyester prepolymer”).

For example, a polyester resin having isocyanate group can be used as the polyester prepolymer. Such a polyester prepolymer is obtainable by reacting a polyester resin having an active hydrogen group with a polyisocyanate. When the second resin includes both a polyester resin and a polyester prepolymer, their monomer compositions may be, but need not necessarily be, the same.

Specific examples of the active hydrogen group include, but are not limited to, hydroxyl group (e.g., alcoholic hydroxyl group, phenolic hydroxyl group), amino group, carboxyl group, and mercapto group. Among these groups, alcoholic hydroxyl group is preferable.

It is preferable that the polyester resin and the polyester prepolymer are partially or entirely compatible with each other, from the viewpoint of improving low-temperature fixability and hot offset resistance of the resultant toner. Therefore, the polyester resin and the polyester prepolymer preferably have similar compositions.

Specific examples of usable polyisocyanates include, but are not limited to, aliphatic polyisocyanates (e.g., tetramethylene diisocyanate, hexamethylene diisocyanate, 2,6-diisocyanatomethylcaproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), and isocyanurates. These can be used alone or in combination.

These polyisocyanates may be blocked by a phenol derivative, an oxime, or a caprolactam, if desired.

When a polyester resin having hydroxyl group reacts with a polyisocyanate, the equivalent ratio of isocyanate group to hydroxyl group is preferably 1 to 5, more preferably from 1.2 to 4, and much more preferably from 1.5 to 2.5. When the equivalent ratio is too large, low-temperature fixability of the resultant toner may deteriorate. When the equivalent ratio is too small, hot offset resistance of the resultant toner may deteriorate, because the resultant modified polyester resin obtained by a cross-linking and/or elongation reaction, to be explained later, includes a less amount of urea bond.

The polyester prepolymer preferably includes polyisocyanate-originated components in an amount of from 0.5 to 30% by weight, more preferably from 1 to 30% by weight, and much more preferably from 2 to 20% by weight. When the amount is too small, hot offset resistance of the resultant toner may deteriorate. When the amount is too large, both thermostable preservability and low-temperature fixability of the resultant toner may deteriorate.

The polyester prepolymer preferably includes one or more isocyanate groups, preferably 1.5 to 3, and much more preferably 1.8 to 2.5, per molecule on average. When the number of isocyanate groups is too small, the resultant modified polyester resin obtained by a cross-linking and/or elongation reaction may have too small a molecular weight, degrading hot offset resistance of the resultant toner.

The binder resin preferably includes the polyester prepolymer, as the second resin, in an amount of from 5 to 30% by weight, and more preferably from 10 to 20% by weight. When the amount is too small, both thermostable preservability and low-temperature fixability of the resultant toner may deteriorate. When the amount is too large, hot offset resistance of the resultant toner may deteriorate.

The polyester prepolymer is preferably reacted with a compound having an active hydrogen group (hereinafter “a crosslinking and/or elongation agent”), in an aqueous medium. (This reaction is hereinafter referred to as a crosslinking and/or elongation reaction.)

As the crosslinking and/or elongation agent, amines such as divalent amines, amines having 3 or more valences, amino alcohols, aminomercaptans, and amino acids, are preferably used. Specific examples of usable divalent amines include, but are not limited to, aromatic diamines (e.g., phenylenediamine, diethyltoluenediamine, 4,4′-diaminodiphenylmethane); alicyclic diamines (e.g., 4,4′-diamino-3,3′-dimethyldicyclohexylmethane, diaminocyclohexane, isophoronediamine); and aliphatic diamines (e.g., ethylenediamine, tetramethylenediamine, hexamethylenediamine). Specific examples of usable amines having 3 or more valences include, but are not limited to, diethylenetriamine and triethylenetetramine. Specific examples of usable amino alcohols include, but are not limited to, ethanolamine and hydroxyethylaniline. Specific examples of usable amino mercaptans include, but are not limited to, aminoethyl mercaptan and aminopropyl mercaptan. Specific examples of usable amino acids include, but are not limited to, aminopropionic acid and aminocaproic acid. In addition, amines in which amino group is blocked, such as ketimine compounds and oxazoline compounds blocked with ketones such as acetone, methyl ethyl ketone, and methyl isobutyl ketone, can also be used. Among these compounds, divalent amines and mixtures of a divalent amine with a small amount of an amine having 3 or more valences are preferably used.

A reaction terminator may be optionally used for the crosslinking and/or elongation reaction, if desired, for controlling the molecular weight of the resultant modified polyester resin. Specific examples of usable reaction terminators include, but are not limited to, monoamines (e.g., diethylamine, dibutylamine, butylamine, laurylamine) and monoamines in which amino group is blocked (e.g., ketimine compounds and oxazoline compounds blocked with ketones such as acetone, methyl ethyl ketone, and methyl isobutyl ketone).

When the polyester prepolymer reacts with the amine in the crosslinking and/or elongation reaction, the equivalent ratio of isocyanate group in the polyester prepolymer to amino group in the amine is preferably 1/3 to 3, more preferably from 1/2 to 2, and much more preferably from 2/3 to 1.5. When the equivalent ratio is too small or large, the resultant modified polyester resin may have too small a molecular weight, resulting in poor hot offset resistance of the resultant toner.

The first resin preferably has a glass transition temperature (Tg) of from 40 to 70° C., and more preferably from 45 to 65° C., from the viewpoint of improving preservability of the resultant toner. When the Tg is too low, the resultant toner may deteriorate in high-temperature atmosphere, thereby causing offset when fixed. When the Tg is too high, the resultant toner may have poor fixability.

The binder resin may further include resins other than the first and second resins. Specific examples of usable resins include, but are not limited to, homopolymers or copolymers of styrene monomers, acrylic monomers, methacrylic monomers, and the like monomers, polyol resins, phenol resins, silicone resins, polyurethane resins, polyamide resins, furan resins, epoxy resins, xylene resins, terpene resins, coumarone-indene resins, polycarbonate resins, and petroleum resins. These resins can be used alone or in combination.

The toner of the present invention preferably includes an additive which accelerates crystallization. Specific preferred examples of usable additives include, but are not limited to, compounds having the following formula (2) such as an N-substituted aliphatic acid bisamide, and compounds having the following formula (3) such as a sorbitol-based nucleating agent.

The N-substituted aliphatic acid bisamide represented by the following formula (2) acts as a nucleating agent which accelerates crystallization of a polylactic acid. Therefore, deterioration of hot offset resistance of a toner including a resin comprising a block comprising a polylactic acid may be suppressed.

The sorbitol-based nucleating agent represented by the following formula (3) also accelerates crystallization of a polylactic acid. Therefore, variation in charge of toner particles including a resin comprising a block comprising a polylactic acid may be suppressed.

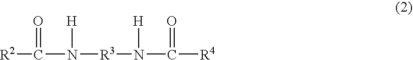

In the formula (2), R3 represents an alkylene group having 1 to 6 carbon atoms or a functional group having the following formula:

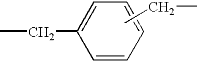

Specific examples of the alkylene group having 1 to 6 carbon atoms in the formula (2) include, but are not limited to, methylene group, ethylene group, propylene group, and butylene group.

Each of R2 and R4 independently represents a saturated or unsaturated straight-chain aliphatic hydrocarbon group having 11 to 21 carbon atoms, derived from lauric acid, stearic acid, oleic acid, behenic acid, and the like.

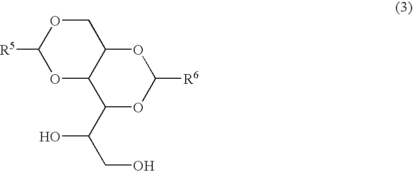

In the formula (3), each of R5 and R6 independently represents an alkyl group having 1 to 5 carbon atoms, an alkoxy group having 1 to 5 carbon atoms, or a functional group having the following formula (4):

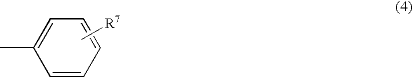

In the formula (4), R7 represents a hydrogen atom, a halogen atom, an alkyl group having 1 to 5 carbon atoms, or an alkoxy group having 1 to 5 carbon atoms.

Specific examples of the halogen atoms include, but are not limited to, fluorine, chlorine, bromine, and iodine.

Specific examples of the alkyl group having 1 to 5 carbon atoms in the formulae (3) and (4) include, but are not limited to, methyl group, ethyl group, propyl group, and butyl group. Specific examples of the alkoxy group having 1 to 5 carbon atoms in the formulae (3) and (4) include, but are not limited to, methoxy group, ethoxy group, propoxy group, and butoxy group.

Specific examples of the N-substituted aliphatic acid bisamide represented by the following formula (2) include, but are not limited to, N,N′-ethylene bis(lauric acid amide), N,N′-methylene bis(stearic acid amide), N,N′-ethylene bis(stearic acid amide), N,N′-ethylene bis(oleic acid amide), N,N′-ethylene bis(behenic acid amide), N,N′-ethylene bis(12-hydroxystearic acid amide), N,N′-butylene bis(stearic acid amide), N,N′-hexamethylene bis(stearic acid amide), N,N′-hexamethylene bis(oleic acid amide), and N,N′-xylylene bis(lauric acid amide).

Specific examples of the sorbitol-based nucleating agent represented by the formula (3) include, but are not limited to, 1,3-benzylidene-2,4-p-methylbenzylidene sorbitol, 1,3-p-methylbenzylidene-2,4-benzylidene sorbitol, 1,3-benzylidene-2,4-o-methylbenzylidene sorbitol, 1,3-o-methylbenzylidene-2,4-benzylidene sorbitol, 1,3,2,4-bis(p-methylbenzylidene)sorbitol, 1,3,2,4-bis(o-methylbenzylidene)sorbitol, 1,3,2,4-bis(p-ethylbenzylidene)sorbitol, 1,3,2,4-bis(p-methoxybenzylidene)sorbitol, and 1,3,2,4-bis(p-chlorobenzylidene)sorbitol.

The toner preferably includes the additive (i.e., the N-substituted aliphatic acid bisamide or the sorbitol-based nucleating agent) in an amount of from 0.5 to 5 parts by weight, and more preferably from 1 to 2.5 parts by weight, per 100 parts by weight of the first and second resins. When the amount is too small, the additive may not sufficiently function. When the amount is too large, a colorant and a release agent may not be well dispersed in the resultant toner.

In particular, the toner preferably includes the additive (i.e., the N-substituted aliphatic acid bisamide or the sorbitol-based nucleating agent) in an amount of from 0.5 to 5 parts by weight, and more preferably from 1 to 2.5 parts by weight, per 100 parts by weight of the first resin. When the amount is too small, the first resin may not be sufficiently crystallized, resulting in poor durability of the resultant toner. Alternatively, the first resin may be crystallized when the resultant toner is stored, resulting in deterioration of low-temperature fixability compared to the resultant toner in initial state. When the amount is too large, the additive and a colorant may be exposed at the surface of the resultant toner, resulting in unstable charge of the resultant toner.

Specific examples of colorants for use in the toner of the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These materials can be used alone or in combination.

The toner preferably includes the colorant in an amount of from 1 to 15% by weight, and more preferably from 3 to 10% by weight. When the amount is too small, coloring power of the resultant toner may deteriorate. When the amount is too large, the colorant may not be well dispersed in the resultant toner, resulting in deterioration of coloring power and electric properties of the resultant toner.

The colorant for use in the present invention can be combined with a resin to be used as a master batch. Specific examples of the resin for use in the master batch include, but are not limited to, polyester, polymers of styrenes or substitutions thereof, styrene copolymers, polymethyl methacrylate, polybutyl methacrylate, polyvinyl chloride, polyvinyl acetate, polyethylene, polypropylene, epoxy resins, epoxy polyol resins, polyurethane, polyamide, polyvinyl butyral, polyacrylic acid resins, rosin, modified rosin, terpene resins, aliphatic hydrocarbon resins, alicyclic hydrocarbon resins, aromatic petroleum resins, chlorinated paraffin, and paraffin wax. These resins can be used alone or in combination. Among these resins, polymers of styrenes or substitutions thereof are preferably used.

Specific examples of the polymers of styrenes or substitutions thereof include, but are not limited to, polystyrene, poly(p-chlorostyrene), and polyvinyl toluene. Specific examples of the styrene copolymers include, but are not limited to, styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloro methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

The toner of the present invention may include a release agent and a charge controlling agent, if desired, other than the binder resin and the colorant.

As the release agent, waxes are preferably used.

Specific examples of usable waxes include, but are not limited to, low-molecular-weight polyolefin waxes, synthesized hydrocarbon waxes, natural waxes, petroleum waxes, higher aliphatic acids and metal salts thereof, higher aliphatic acid amide, and modified waxes thereof. These waxes can be used alone or in combination.

Specific examples of the low-molecular-weight polyolefin waxes include, but are not limited to, low-molecular-weight polyethylene wax and low-molecular-weight polypropylene wax. Specific examples of the synthesized hydrocarbon waxes include, but are not limited to, Fisher-Tropsch wax. Specific examples of the natural waxes include, but are not limited to, beeswax, carnaubawax, candelilla wax, rice wax, and montan wax. Specific examples of the petroleum waxes include, but are not limited to, paraffin wax and microcrystalline wax. Specific examples of the higher aliphatic acids include, but are not limited to, stearic acid, palmitic acid, and myristic acid.

The release agent preferably has a melting point of from 40 to 160° C., more preferably from 50 to 120° C., and much more preferably from 60 to 90° C. When the melting point is too low, the wax may degrade thermostable preservability of the resultant toner. When the melting point is too high, the resultant toner may easily cause cold offset when fixed at low temperatures. Alternatively, a recording medium such as paper may wind around a fixing member.

The toner preferably includes the release agent in an amount of 40% by weight or less, and more preferably 3 to 30% by weight. When the amount is too large, the resultant toner may have poor low-temperature fixability. In addition, the resultant image may have too high a glossiness, thereby degrading image quality.

Specific examples of usable charge controlling agent include, but are not limited to, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing surfactants, metal salts of salicylic acid, and metal salts of salicylic acid derivatives. These materials can be used alone or in combination.

Specific examples of commercially available charge controlling agents include, but are not limited to, BONTRON® N-03 (Nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as sulfonate group, carboxyl group, and a quaternary ammonium group.

The toner preferably includes the charge controlling agent in an amount of from 0.1 to 10 parts by weight, and preferably from 0.2 to 5 parts by weight, per 100 parts by weight of the binder resin. When the amount is too small, charge of the resultant toner may be uncontrollable. When the amount is too large, the toner has too large a charge quantity, and thereby increasing electrostatic attracting force between a developing roller. Consequently, fluidity of the resultant toner and image density of the resultant image may deteriorate.

The toner of the present invention may further include a particulate inorganic material, a cleanability improving agent, and a magnetic material, if desired.

The particulate inorganic material serves as an external additive which imparts fluidity, developability, and chargeability to the resultant toner. Specific examples of usable particulate inorganic materials include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. These materials can be used alone or in combination.

The particulate inorganic material preferably has a primary particle diameter of from 5 nm to 2 μm, and more preferably from 5 to 500 nm.

The toner preferably includes the particulate inorganic material in an amount of from 0.01 to 5.0% by weight, and more preferably from 0.01 to 2.0% by weight.

The particulate inorganic material is preferably surface-treated with a fluidity improving agent. Accordingly, hydrophobicity of the particulate inorganic material is improved, thereby preventing deterioration of fluidity and chargeability of the resultant toner even in high-humidity conditions. Specific examples of the fluidity improving agent include, but are not limited to, silane coupling agents, silylation agents, silane coupling agents having a fluorinated alkyl group, organic titanate coupling agents, aluminum coupling agents, silicone oils, and modified silicone oils. In particular, silica and titanium oxide are preferably surface-treated with a fluidity improving agent so as to be used as a hydrophobized silica and a hydrophobized titanium oxide, respectively.

The cleanability improving agent is added to the toner so as to be easily removed when remaining on a photoreceptor or a primary transfer medium after a toner image is transferred onto a recording medium, and the like. Specific examples of the cleanability improving agents include, but are not limited to, metal salts of aliphatic acids such as zinc stearate and calcium stearate; and fine particles of polymers which are manufactured by a soap-free emulsion polymerization method, such as polymethyl methacrylate and polystyrene. The fine particles of a polymer preferably have a narrow particle diameter distribution, and a volume average particle diameter of from 0.01 to 1 μm.

Specific examples of usable magnetic materials include, but are not limited to, iron powders, magnetite, and ferrite. Considering the color tone of the resultant toner, whitish magnetic materials are preferably used.

The toner of the present invention preferably has a volume average particle diameter (Dv) of from 3 to 8 μm, and a ratio (Dv/Dn) of the volume average particle diameter (Dv) to a number average particle diameter (Dn) of from 1.00 to 1.25. When such a toner is used for a two-component developer, the average particle diameter of the toner hardly varies therein, even when consumption and supply of toner particles are repeated for a long period of time. In particular, fresh toner particles of the same amount as those that of toner particles consumed for development are supplied. Accordingly, the toner has reliable developability even after being agitated in a developing device for a long period of time. Typically, toner particles having a larger particle diameter are immediately consumed. As a result, the two-component developer includes a large amount of toner particles having a smaller particle diameter after a long-term continuous printing. When such a toner is used for a one-component developer, the toner hardly forms a toner film on a developing roller or adheres to a blade for forming a thin toner layer. Accordingly, the toner has reliable developability even after being agitated in a developing device for a long period of time.

Generally speaking, the smaller the average particle diameter of a toner, the better the resultant image resolution and quality. By contrast, the smaller the average particle diameter of a toner, the worse transferability and cleanability of the toner. When a toner having a volume average particle diameter of less than 3 μm is used for a two-component developer, the toner may adhere to the surface of a carrier, thereby degrading charging ability of the carrier. When such a toner is used for a one-component developer, the toner may easily form a toner film on a developing roller or adheres to a blade for forming a thin toner layer.

When the toner has a volume average particle diameter of greater than 8 μm or a ratio (Dv/Dn) of greater than 1.25, high-resolution and high-quality images are hardly produced. In addition, the average particle diameter of the toner largely varies therein, when consumption and supply of toner particles are repeated for a long period of time.

The volume average particle diameter (Dv) and number average particle diameter (Dn) of a toner can be measured using an instrument such as a COULTER MULTISIZER III (from Beckman Coulter K. K.) with an aperture diameter of 100 μm, for example. A measurement result can be analyzed with an analysis software program such as Beckman Coulter Multisizer 3 Version 3.51.

The typical measuring method is as follows. First, 0.5 ml of an aqueous solution including 10% by weight of an alkylbenzenesulfonate (NEOGEN SC-A from Dai-ichi Kogyo Seiyaku Co., Ltd.) and 0.5 g of a toner are added to a 100 ml glass beaker and mixed using a micro spatula, and 80 ml of ion-exchanged water is further added thereto, to prepare a sample dispersion. The sample dispersion is subjected to a dispersion treatment using an ultrasonic dispersing machine 13MK-II (from Honda Electronics) for 10 minutes. Thereafter, the sample dispersion is subjected to a measurement using COULTER MULTISIZER III with a measurement solution ISOTON-II (from Coulter Electrons Inc.), so that the COULTER MULTISIZER III indicates a sample density of from 8±2%.

Thus, the volume average particle diameter (Dv) and number average particle diameter (Dn) of a toner are measured.

The toner of the present invention is generally obtained by a method including: emulsifying or dispersing a toner constituent liquid, in which toner constituents comprising a binder resin and a colorant are dissolved or dispersed in an organic solvent, in an aqueous medium. In particular, the method preferably includes the following steps of (1) to (6).

### (1) Preparation of Toner Constituent Liquid

The toner constituent liquid is prepared by dissolving or dispersing toner constituents in an organic solvent. Specific examples of usable organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These organic solvents can be used alone or in combination. Among these organic solvents, ester solvents are preferably used, because polyester resins have good solubility in ester solvents. More particularly, ethyl acetate is more preferably used, because of being easily removable.

The toner constituent liquid preferably includes the organic solvent in an amount of 40 to 300 parts by weight, more preferably 60 to 140 parts by weight, and much more preferably from 80 to 120 parts by weight, per 100 parts by weight of the toner constituents.

### (2) Preparation of Aqueous Medium

The aqueous medium is prepared by dispersing a particulate resin in an aqueous solvent, for example. The aqueous medium preferably includes the particulate resin in an amount of from 0.5 to 10% by weight.

Specific examples of usable aqueous solvent include, but are not limited to, water, solvents having miscibility with water, and mixtures thereof. Among these, water is preferably used. Specific examples of the solvents having miscibility with water include, but are not limited to, alcohols (e.g., methanol, isopropanol, ethylene glycol), dimethylformamide, tetrahydrofuran, cellosolves, and lower ketones (e.g., acetone, methyl ethyl ketone).

As the particulate resin, any known resins capable of being dispersed in an aqueous medium can be used.

Specific examples of such resins include, but are not limited to, thermoplastic and thermosetting resins such as vinyl resins, polyurethane resins, epoxy resins, polyester resins, polyamide resins, polyimide resins, silicone resins, phenol resins, melamine resins, urea resins, aniline resins, ionomer resins, and polycarbonate resins. These resins can be used alone or in combination. Among these resins, vinyl resins, polyurethane resins, epoxy resins, and polyester resins are preferably used, because these resins easily from an aqueous dispersion containing fine particles thereof. The vinyl resins refer to resins obtained from homopolymerization or copolymerization of a vinyl monomer. Specific examples of the vinyl resins include, but are not limited to, styrene-(meth)acrylate copolymers, styrene-butadiene copolymers, (meth)acrylic acid-acrylate copolymers, styrene-acrylonitrile copolymers, styrene-maleic anhydride copolymers, and styrene-(meth)acrylic acid copolymers.

In addition, the particulate resin can be prepared from a monomer having 2 or more unsaturated groups. Specific examples of the monomer having 2 or more unsaturated groups include, but are not limited to, sodium salt of sulfate of ethylene oxide adduct of methacrylic acid, divinylbenzene, and 1,6-hexanediol diacrylate.

The particulate resin can be prepared by a known polymerization method, and preferably prepared in a state of an aqueous dispersion thereof. Specific preferred methods for forming an aqueous dispersion of a particulate resin include the following methods of (a) to (h), for example.

(a) Subjecting a vinyl monomer to any one of suspension polymerization, emulsion polymerization, seed polymerization, and dispersion polymerization, so that an aqueous dispersion of a particulate resin is directly prepared.
(b) Dispersing a precursor (such as a monomer and an oligomer) of a polyaddition or polycondensation resin (such as a polyester resin, a polyurethane resin, and an epoxy resin) or a solvent solution thereof in an aqueous medium in the presence of a suitable dispersing agent, followed by heating or adding a curing agent, so that an aqueous dispersion of a particulate resin is prepared.
(c) Dissolving a suitable emulsifying agent in a precursor (such as a monomer and an oligomer) of a polyaddition or polycondensation resin (such as a polyester resin, a polyurethane resin, and an epoxy resin) or a solvent solution (preferably in liquid form, if not liquid, preferably liquefied by application of heat) thereof, and subsequently adding water thereto, so that an aqueous dispersion of a particulate resin is prepared by phase-inversion emulsification.
(d) Pulverizing a resin previously formed by a polymerization reaction (such as addition polymerization, ring-opening polymerization, polyaddition, addition condensation, condensation polymerization) using a mechanical rotational type pulverizer or a jet type pulverizer, classifying the pulverized particles to prepare a particulate resin, and dispersing the particulate resin in an aqueous medium in the presence of a suitable dispersing agent, so that an aqueous dispersion of the particulate resin is prepared.
(e) Spraying a resin solution, in which a resin previously formed by a polymerization reaction (such as addition polymerization, ring-opening polymerization, polyaddition, addition condensation, condensation polymerization) is dissolved in a solvent, into the air to prepare a particulate resin, and dispersing the particulate resin in an aqueous medium in the presence of a suitable dispersing agent, so that an aqueous dispersion of the particulate resin is prepared.
(f) Adding a poor solvent to a resin solution, in which a resin previously formed by a polymerization reaction (such as addition polymerization, ring-opening polymerization, polyaddition, addition condensation, condensation polymerization) is dissolved in a solvent, or cooling the resin solution which is previously dissolved in a solvent with application of heat, to precipitate a particulate resin, and dispersing the particulate resin in an aqueous medium in the presence of a suitable dispersing agent, so that an aqueous dispersion of the particulate resin is prepared.
(g) Dispersing a resin solution, in which a resin previously formed by a polymerization reaction (such as addition polymerization, ring-opening polymerization, polyaddition, addition condensation, condensation polymerization) is dissolved in a solvent, in an aqueous medium in the presence of a suitable dispersing agent, and removing the solvent by application of heat, reduction of pressure, and the like, so that an aqueous dispersion of a particulate resin is prepared.
(h) Dissolving a suitable emulsifying agent in a resin solution, in which a resin previously formed by a polymerization reaction (such as addition polymerization, ring-opening polymerization, polyaddition, addition condensation, condensation polymerization) is dissolved in a solvent, and subsequently adding water thereto, so that an aqueous dispersion of a particulate resin is prepared by phase-inversion emulsification.

The aqueous medium preferably contains a dispersing agent, so that droplets of the toner constituent liquid are reliably formed when emulsified or dispersed. Accordingly, the resultant toner may have a desired shape and a narrow particle diameter distribution.

Specific examples of the dispersing agent include, but are not limited to, surfactants, water-insoluble inorganic dispersants, and polymeric protective colloids. These can be used alone or in combination. Among these materials, anionic surfactants, cationic surfactants, nonionic surfactants, and ampholytic surfactants are more preferably used.

Specific examples of the anionic surfactants include, but are not limited to, alkylbenzene sulfonates, α-olefinsulfonates, and phosphates. These anionic surfactants preferably have a fluoroalkyl group. Specific examples of the anionic surfactants having a fluoroalkyl group include, but are not limited to, fluoroalkyl carboxylic acids having 2 to 10 carbon atoms and metal salts thereof, disodium perfluorooctanesulfonyl glutamate, sodium 3-{ω-fluoroalkyl(C6-C11)oxy}-1-alkyl(C3-C4) sulfonate, sodium 3-{ω-fluoroalkanoyl(C6-C8)-N-ethylamino}-1-propane sulfonate, fluoroalkyl(C11-C20) carboxylic acids and metal salts thereof, perfluoroalkyl(C7-C13) carboxylic acids and metal salts thereof, perfluoroalkyl(C4-C12) sulfonate and metal salts thereof, perfluorooctanesulfonic acid diethanol amide, N-propyl-N-(2-hydroxyethyl)perfluorooctanesulfone amide, perfluoroalkyl(C6-C10) sulfoneamidepropyltrimethyl ammonium salts, salts of perfluoroalkyl(C6-C10)-N-ethylsulfonyl glycin, and monoperfluoroalkyl(C6-C16)ethyl phosphates.

Specific examples of usable commercially available anionic surfactants having a fluoroalkyl group include, but are not limited to, SARFRON® S-111, S-112 and S-113 (manufactured by Asahi Glass Co., Ltd.); FLUORAD®FC-93, FC-95, FC-98 and FC-129 (manufactured by Sumitomo 3M Ltd.); UNIDYNE® DS-101 and DS-102 (manufactured by Daikin Industries, Ltd.); MEGAFACE® F-110, F-120, F-113, F-191, F-812 and F-833 (manufactured by Dainippon Ink and Chemicals, Inc.); ECTOP® EF-102, 103, 104, 105, 112, 123A, 123B, 306A, 501, 201 and 204 (manufactured by Tochem Products Co., Ltd.); and FUTARGENT® F-100 and F-150 (manufactured by Neos).

Specific examples of the cationic surfactants include, but are not limited to, amine salts and quaternary ammonium salts. Specific examples of the amine salts include, but are not limited to, alkyl amine slats, amino alcohol aliphatic acid derivatives, polyamine aliphatic acid derivatives, and imidazoline. Specific examples of the quaternary ammonium salts include, but are not limited to, alkyltrimethyl ammonium salts, dialkyldimethyl ammonium salts, alkyldimethyl benzyl ammonium salts, pyridinium salts, alkyl isoquinolinium salts, and benzethonium chloride. Among these, aliphatic primary, secondary, and tertiary amine salts having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, and imidazolinium salts are preferably used.

Specific examples of usable commercially available cationic surfactants include, but are not limited to, SARFRON® S-121 (manufactured by Asahi Glass Co., Ltd.); FLUORAD® FC-135 (manufactured by Sumitomo 3M Ltd.); UNIDYNE® DS-202 (manufactured by Daikin Industries, Ltd.); MEGAFACE® F-150 and F-824 (manufactured by Dainippon Ink and Chemicals, Inc.); ECTOP® EF-132 (manufactured by Tohchem Products Co., Ltd.); and FUTARGENT® F-300 (manufactured by Neos).

Specific examples of the nonionic surfactants include, but are not limited to, aliphatic acid amide derivatives and polyhydric alcohol derivatives.

Specific examples of the ampholytic surfactants include, but are not limited to, aniline, dodecylbis(aminoethyl)glycin, bis(octylaminoethyl)glycin, and N-alkyl-N,N-dimethylammonium betaine.

Specific examples of the water-insoluble inorganic dispersants include, but are not limited to, tricalcium phosphate, calcium carbonate, titanium oxide, colloidal silica, and hydroxyapatite.

Specific examples of the polymeric protection colloids include, but are not limited to, homopolymers and copolymers of monomers such as acid monomers, (meth) acrylic monomers having hydroxyl group, ethers of vinyl alcohols, esters of vinyl alcohols with compounds having carboxyl group, monomers having amide bond and methylol compounds thereof, acid chloride monomers, and monomers having a nitrogen atom or a heterocyclic ring having a nitrogen atom; polyoxyethylene resins; and cellulose compounds.

Specific examples of the acid monomers include, but are not limited to, acrylic acid, methacrylic acid, α-cyanoacrylic acid, α-cyanomethacrylic acid, itaconic acid, crotonic acid, fumaric acid, maleic acid, and maleic anhydride.

Specific examples of the (meth)acrylic monomers having hydroxyl group include, but are not limited to, β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acrylamide, and N-methylol methacrylamide.

Specific examples of the ethers of vinyl alcohols include, but are not limited to, vinyl methyl ether, vinyl ethyl ether, and vinyl propyl ether.

Specific examples of the esters of vinyl alcohols with compounds having carboxyl group include, but are not limited to, vinyl acetate, vinyl propionate, and vinyl butyrate.

Specific examples of the monomers having amide bond include, but are not limited to, acrylamide, methacrylamide, diacetoneacrylamide acid.

Specific examples of the acid chloride monomers include, but are not limited to, acrylic acid chloride and methacrylic acid chloride.

Specific examples of the monomers having a nitrogen atom or a heterocyclic ring having a nitrogen atom include, but are not limited to, vinyl pyridine, vinyl pyrrolidone, vinyl imidazole, and ethylene imine.

Specific examples of the polyoxyethylene resins include, but are not limited to, polyoxyethylene, polyoxypropylene, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters, and polyoxyethylene nonylphenyl esters.

Specific examples of the cellulose compounds include, but are not limited to, methyl cellulose, hydroxyethyl cellulose, and hydroxypropyl cellulose.

When an aqueous dispersion of a particulate is prepared, a dispersion stabilizer can be optionally used. Specific examples of usable dispersion stabilizers include, but are not limited to, calcium phosphate, which is soluble both in acids and bases.

When the binder resin includes the polyester prepolymer, the aqueous medium may include a catalyst for urea or urethane reaction, such as dibutyltin laurate and dioctyltin laurate.

### (3) Preparation of Emulsion Slurry

An emulsion slurry is prepared by emulsifying or dispersing the toner constituent liquid in the aqueous medium. The emulsification or dispersion is preferably performed under agitation. Specific examples of usable emulsification or dispersion apparatuses include, but are nor limited to, batch emulsifiers such as homogenizer (from IKA Japan), POLYTRON® (from KINEMATICA AG), and TK AUTO HOMO MIXER® (from Tokushu Kika Kogyo Co., Ltd.); continuous emulsifiers such as EBARA MILDER® (from Ebara Corporation), TK FILMICS and TK PIPELINE HOMO MIXER® (from Tokushu Kika Kogyo Co., Ltd.), colloid mill (from SHINKO PANTEC CO., LTD.), slasher and trigonal wet pulverizer (from Mitsui Miike Machinery Co., Ltd.), CAVITRON® (from Eurotec), and FINE FLOW MILL® (from Pacific Machinery & Engineering Co., Ltd.); high-pressure emulsifiers such as microfluidizer (from Mizuho Industrial Co., Ltd.), NANOMIZER (from Advanced Nano Technology Co, Ltd.), APV GAULIN homogenizer (from APV Gaulin Inc.); film emulsifier (from Reica Co., Ltd.); vibration emulsifier such as VIBROMIXER (from Reica Co., Ltd.); and ultrasonic emulsifiers such as SONIFIER (from Branson Ultrasonics Corporation). Among these apparatuses, APV GAULIN homogenizer, homogenizer, TK AUTO HOMO MIXER®, EBARA MILDER®, TK FILMICS, and TK PIPELINE HOMO MIXER® are preferably used from the viewpoint of uniformity of the particle diameter.

### (4) Removal of Solvent

The organic solvent is removed from the emulsion slurry by the following methods, for example: gradually heating the emulsion slurry to completely evaporate the organic solvent present therein; or spraying the emulsion slurry into a dry atmosphere to evaporate the organic solvent and the aqueous solvent therefrom.

### (5) Washing, Drying, and Classification

After the organic solvent is removed from the emulsion slurry, mother toner particles are formed. The mother toner particles may be subjected to washing and drying, and optionally classification. For example, the classification of the mother toner particles may be performed by methods such as cyclone, decantation, and centrifugal separation in an aqueous medium, because fine particles can be removed. Alternatively, the dried mother toner particles may be subjected to classification.

When the dispersion stabilizer includes a compound which is soluble both in acids and bases, such as calcium phosphate, the dispersion stabilizer may be dissolved by an acid such as hydrochloric acid, and then washed with water, so that the dispersion stabilizer is removed from the mother toner particles.

### (6) External Addition of Particulate Inorganic Material

The mother toner particles may be optionally mixed with a particulate inorganic material such as titanium oxide. Further, mechanical impact may be applied thereto so that the particulate inorganic material does not release from the surfaces of the mother toner particles. Mechanical impact is applied to the particles by the following methods, for example: rotating agitation blade at a high speed; or putting the particles in a high-speed gas flow so that the particles or the combined particles collide with a collision plate. Specific examples of usable mechanical impact applicators include, but are not limited to, ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTON SYSTEM (manufactured by Kawasaki Heavy Industries, Ltd.), and automatic mortars.

The color of the toner of the present invention is not particularly limited. The toner may be one of black, cyan, magenta, and yellow toner. A desired-color toner may be obtained by using appropriate colorants described above.

The developer of the present invention comprises the toner, and other components such as a carrier, if desired. The developer may be either a one-component developer consisting essentially of the toner or a two-component developer including the toner and a carrier. In accordance with recent improvements in information processing speed of printers, two-component developers are preferably used from the viewpoint of life.

When the toner is used for a one-component developer, the average particle diameter of the toner hardly varies therein, even when consumption and supply of toner particles are repeated for a long period of time. Furthermore, the toner hardly forms a toner film on a developing roller or adheres to a blade for forming a thin toner layer. Accordingly, the toner has reliable developability even after being agitated in a developing device for a long period of time. When the toner is used for a two-component developer, the average particle diameter of the toner hardly varies therein, even when consumption and supply of toner particles are repeated for a long period of time. Accordingly, the toner has reliable developability even after being agitated in a developing device for a long period of time.

The carrier preferably includes a core and a resin layer covering the core.

Specific preferred examples of usable materials for the core include, but are not limited to, manganese-strontium (Mn—Sr) and manganese-magnesium (Mn—Mg) materials having a magnetization of from 50 to 90 emu/g. In terms of high image density, high-magnetization materials such as iron powders having a magnetization of 100 emu/g or more and magnetites having a magnetization of from 75 to 120 emu/g are preferably used. In terms of high image quality, low-magnetization materials such as copper-zinc (Cu—Zn) materials having a magnetization of from 30 to 80 emu/g are preferably used, because a magnetic brush thereof may weakly contact a photoconductor. These materials can be used alone or in combination.

The core preferably has a volume average particle diameter of from 10 to 150 μm, and more preferably from 20 to 80 μm.

When the volume average particle diameter is too small, the carrier excessively includes fine particles, thereby reducing magnetization per molecule. Consequently, carrier particles may scatter. When the volume average particle diameter is too large, the carrier has a low specific area. Consequently, toner particles may scatter, or a solid image portion may not be reliably reproduced.

Specific preferred examples of usable resins for the resin layer include, but are not limited to, amino resins, polyvinyl resins, polystyrene resins, halogenated olefin resins, polyester resins, polycarbonate resins, polyethylene resins, polyvinyl chloride resins, polyvinylidene chloride resins, polytrifluoroethylene resins, polyhexafluoropropylene resins, copolymers of vinylidene fluoride and an acrylic monomer, copolymers of vinylidene fluoride and vinyl fluoride, terpolymers of tetrafluoroethylene, vinylidene fluoride, and a non-fluorinated monomer, and silicone resins. These resins can be used alone or in combination.

Specific examples of the amino resins include, but are not limited to, urea-formamide resins, melamine resins, benzoguanamine resins, urea resins, polyamide resins, and epoxy resins. Specific examples of the polyvinyl resins include, but are not limited to, acrylic resins, polymethyl methacrylate resins, polyacrylonitrile resins, polyvinyl acetate resins, polyvinyl alcohol resins, and polyvinyl butyral resins. Specific examples of the polystyrene resins include, but are not limited to, polystyrene resins and styrene-acrylic copolymer resins. Specific examples of the halogenated olefin resins include, but are not limited to, polyvinyl chloride. Specific examples of the polyester resins include, but are not limited to, polyethylene terephthalate resins and polybutylene terephthalate resins.

The resin layer may include a conductive power. Specific examples of usable conductive powers include, but are not limited to, metal powders, carbon black, titanium oxide, tin oxide, and zinc oxide. The conductive power preferably has an average particle diameter of 1 μm or less. When the average particle diameter is too large, electric resistance thereof may be hardly controlled.

The resin layer can be formed by, for example, dissolving a silicone resin, etc., in an organic solvent to prepare a cover layer coating liquid, and evenly applying the cover layer coating liquid on the core by known methods such as a dip coating method, a spray coating method, and a brush coating method. The coated core is then subjected to drying and baking.

Specific examples of the organic solvents include, but are not limited to, toluene, xylene, methyl ethyl ketone, methyl isobutyl ketone, and cellosolve butyl acetate.

The baking method can be either or both of an external heating method or an internal heating method. Specific baking methods include methods using a fixed electric furnace, a portable electric furnace, a rotary electric furnace, a burner furnace, and a microwave, but are not limited thereto.

The carrier preferably includes the cover layer in an amount of from 0.01 to 5.0% by weight. When the amount is too small, a uniform resin layer may not be formed on the surface of the core. When the amount is too large, the resin layer may have too large a thickness, thereby causing unite of carrier particles.

When the developer is a two-component developer, the developer preferably includes the carrier in an amount of from 90 to 98% by weight, and more preferably from 93 to 97% by weight.

The developer of the present invention is applicable to any known electrophotographic image forming methods such as a magnetic one-component developing method, a non-magnetic one-component developing method, and a two-component developing method.

The toner or developer of the present invention may be contained in a container. Suitable container may include a main body and a cap.

The container is not limited in size, shape, structure, material, and the like. The container preferably has a cylindrical shape having spiral projections and depressions on the inner surface thereof. Such a container can feed the developer to an ejection opening by rotation. It is more preferable that a part or all of the spiral parts of such a container have a structure like an accordion.

Suitable materials used for the container include materials having good dimensional accuracy. In particular, resins are preferably used. Specific preferred examples of usable resins for the container include, but are not limited to, polyester resins, polyethylene resins, polypropylene resins, polystyrene resins, polyvinylchloride resins, polyacrylic acids, polycarbonate resins, ABS resins, and polyacetal resins.

The container is easily storable, transportable, and treatable. Further, the container is detachable from a process cartridge and an image forming apparatus to feed the developer thereto.

The toner or developer of the present invention can be used for a process cartridge. The process cartridge includes an electrostatic latent image bearing member to bear an electrostatic latent image and a developing device to develop the electrostatic latent image with a toner or developer to form a toner image, and may optionally include other members, if desired.

The developing device includes the above-described container containing the toner or developer of the present invention and a developer bearing member to bear and transport the developer, and may optionally include a layer thickness control member to control the thickness of the toner borne by the developer bearing member.

The process cartridge is detachably attachable to an electrophotographic image forming apparatus, and preferably attached to the image forming apparatus of the present invention to be described later.

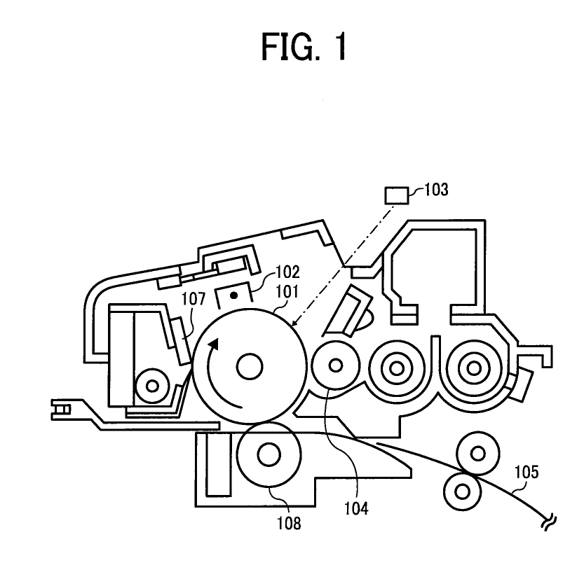

FIG. 1 is a schematic view illustrating an embodiment of the process cartridge.

A process cartridge illustrated in FIG. 1 includes a photoreceptor 101, a charger 102, a developing device 104, a transfer device 108, and a cleaning device 107. In FIG. 1, a reference numeral 103 denotes a light irradiator emitting a light beam and a reference numeral 105 denotes a recording medium.

Next, an image forming process of the process cartridge illustrated in FIG. 1 will be explained. The photoreceptor 101 is charged by the charger 102, and subsequently irradiated with the light beam 103 emitted by the light irradiator (not shown), while rotating in a direction indicated by an arrow so that an electrostatic latent image is formed thereon. The electrostatic latent image is developed with a toner by the developing device 104 to form a toner image, and subsequently the toner image is transferred onto the recording medium 105 by the transfer device 108. The surface of the photoreceptor 101 is cleaned with the cleaning device 107 after the toner image is transferred therefrom, and subsequently decharged by a decharging device (not shown). This image forming operation is repeatedly performed.

The image forming apparatus of the present invention includes an electrostatic latent image bearing member, an electrostatic latent image forming device, a developing device, a transfer device, and a fixing device, and optionally includes a decharge device, a cleaning device, a recycle device, a control device, and the like, if desired.

The image forming apparatus of the present invention forms an image by an image forming method including an electrostatic latent image forming process, a developing process, a transfer process, and a fixing process, and optionally including a decharge process, a cleaning process, a recycle process, a control process, and the like, if desired.

In the electrostatic latent image forming process, an electrostatic latent image is formed on an electrostatic latent image bearing member.

The material, shape, structure, and size of the electrostatic latent image bearing member (hereinafter referred to as photoreceptor, photoconductor, image bearing member, etc.) are not particularly limited. A drum-shaped electrostatic latent image bearing member is preferably used. As for the material, inorganic photoreceptors including amorphous silicon, selenium, etc., and organic photoreceptors including polysilane, phthalopolymethine, etc., can be used as the image bearing member. Among these materials, amorphous silicon is preferably used in terms long life of the electrostatic latent image bearing member.

The electrostatic latent image forming device forms an electrostatic latent image by uniformly charging the surface of the electrostatic latent image bearing member, and subsequently irradiating the charged surface of the electrostatic latent image bearing member with a light beam containing image information, for example.

The electrostatic latent image forming device includes a charger to uniformly charge the surface of the electrostatic latent image bearing member and an irradiator to irradiate the charged surface of the electrostatic latent image bearing member with a light beam containing image information, for example.

In the charging process, the charger applies a voltage to the surface of the electrostatic latent image bearing member.

As the charger, for example, any known contact chargers such as a conductive or semi-conductive roller, brush, film, and rubber blade, and any known non-contact chargers using corona discharge such as corotron and scorotron can be used.

The charger may be provided either in contact or non-contact with the electrostatic latent image bearing member, and charges the surface of the electrostatic latent image bearing member when a direct voltage and an alternating voltage, which are superimposed on each other, are applied thereto.

Alternatively, the charger may include a charging roller provided close to but not in contact with the electrostatic latent image bearing member with a gap tape therebetween. The charging roller may charge the surface of the electrostatic latent image bearing member when a direct voltage and an alternating voltage, which are superimposed on each other, are applied thereto.

In the irradiating process, the charged surface of the electrostatic latent image bearing member is irradiated with a light beam containing image information by the irradiator.

Any known irradiators capable of irradiating the charged surface of the electrostatic latent image bearing member can be used, so that a latent image is formed thereon. For example, irradiators using a radiation optical system, a rod lens array, a laser optical system, a liquid crystal shutter optical system, an LED optical system, etc., can be used.

In the present invention, the electrostatic latent image bearing member may be irradiated with a light beam containing image information from the backside thereof.

In the developing process, the electrostatic latent image is developed with the toner or developer of the present invention to form a toner image.

The developing device forms the toner image by developing the electrostatic latent image with the toner or developer of the present invention.

Any known developing devices capable of developing the electrostatic latent image with the toner or developer of the present invention can be used. For example, a developing device containing the toner or developer of the present invention, preferably contained in the above-described container, and capable of supplying the toner or developer to the electrostatic latent image by either being in or out of contact therewith can be used.

The developing device may be either a single-color or a multi-color developing device. The developing device preferably includes an agitator to agitate the toner or developer so as to be triboelectrically charged and a rotatable magnetic roller, for example.

In the developing device, for example, the toner and the carrier are mixed so that the toner is charged. The developer (i.e., the toner and the carrier) forms magnet brushes on the surface of the rotatable magnetic roller. Since the magnetic roller is provided adjacent to the electrostatic latent image bearing member, apart of the toner that forms the magnetic brushes on the magnetic roller is moved to the surface of the electrostatic latent image bearing member due to an electric attraction force. As a result, the electrostatic latent image is developed with the toner and a toner image is formed on the surface of the electrostatic latent image bearing member.

The developer includes the developer of the present invention.

In the transfer process, a toner image is transferred onto a recording medium. It is preferable that the toner image is firstly transferred onto an intermediate transfer member, and subsequently transferred on to the recording medium. It is more preferable that the transfer process includes a primary transfer process in which two or more monochrome toner images, preferably in full color, are transferred onto the intermediate transfer member to form a composite toner image and a secondary transfer process in which the composite toner image is transferred onto the recording medium.

The transfer process is performed by, for example, charging a toner image formed on the electrostatic latent image bearing member by the transfer device such as a transfer charger. The transfer device preferably includes a primary transfer device to transfer monochrome toner images on to an intermediate transfer member to form a composite toner image and a secondary transfer device to transfer the composite toner image onto a recording medium.

Any known transfer members can be used as the intermediate transfer member. For example, a transfer belt is preferably used.

The transfer device (such as the primary transfer device and the secondary transfer device) preferably includes a transferrer to separate the toner image from the electrostatic latent image bearing member to the recording medium. The transfer device may be used alone or in combination.

As the transferrer, a corona transferrer using corona discharge, a transfer belt, a transfer roller, a pressing transfer roller, an adhesion transferrer, etc., can be used.

As the recording medium, any known recording media (such as a recording paper) can be used.

In the fixing process, the toner image transferred onto a recording medium is fixed thereon by the fixing device. Each of monochrome toner images may be independently fixed on the recording medium. Alternatively, a composite toner image in which monochrome toner images are superimposed on another may be fixed at once.

As the fixing device, any known heat and pressure applying devices are preferably used. As the heat and pressure applying device, a combination of a heat applying roller and a pressure applying roller, a combination of a heat applying roller, a pressure applying roller, and a seamless belt, etc., can be used.

More specifically, the fixing device preferably includes a heating member including a heat generator, a film in contact with the heating member, and a pressing member in contact with the heating member with the film therebetween. A recording medium having an unfixed toner image thereon is passed through between the film and the pressing member so that the toner image is fixed thereon. The heat member preferably heats a heating target to a temperature of from 80 to 200° C.

Any known optical fixing devices may be used alone or in combination with the above-mentioned fixing device in the fixing process of the present invention.

In the decharge process, charges remaining on the electrostatic latent image bearing member are removed by applying a decharge bias to the electrostatic latent image bearing member. The decharge process is preferably performed by a decharge device.

As the decharge device, any known dechargers capable of applying a decharge bias to the electrostatic latent image bearing member can be used. For example, a decharge lamp is preferably used.

In the cleaning process, toner particles remaining on the electrostatic latent image bearing member are removed by a cleaning device.

As the cleaning device, any known cleaners capable of removing toner particles remaining on the electrostatic latent image bearing member can be used. For example, a magnetic brush cleaner, an electrostatic brush cleaner, a magnetic roller cleaner, a blade cleaner, a brush cleaner, a web cleaner, etc. can be used.

In the recycle process, the toner particles removed in the cleaning process are recycled by a recycle device.

As the recycle device, any known feeding devices can be used, for example.

In the control process, each of the processes is controlled by a control device.

As the control device, a sequencer, a computer, etc. can be used.

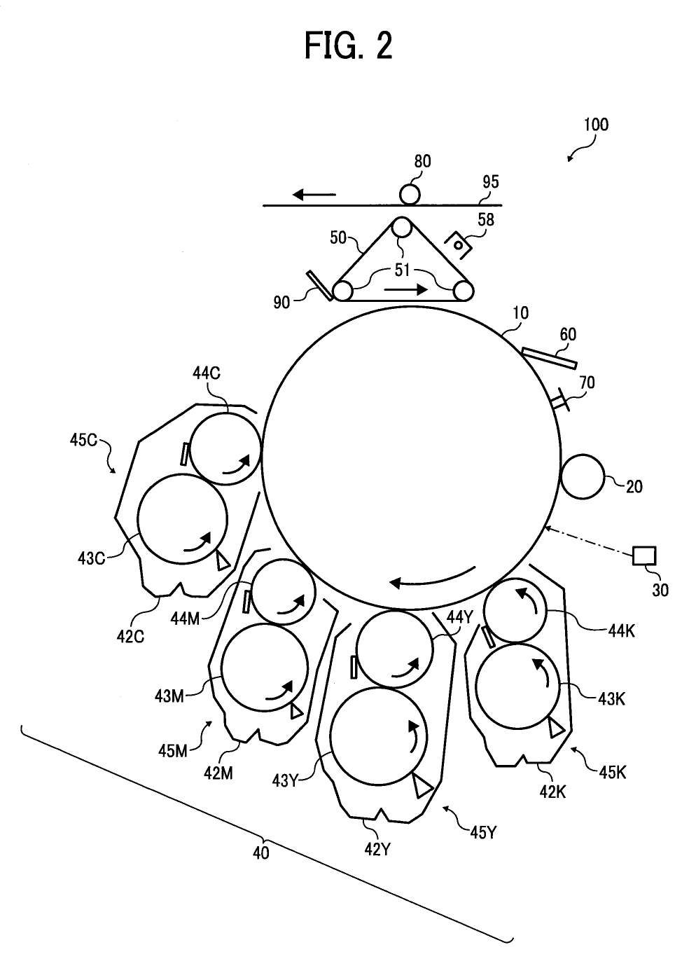

FIG. 2 is a schematic view illustrating an embodiment of the image forming apparatus of the present invention.

An image forming apparatus 100 includes a photoreceptor 10 serving as the electrostatic latent image bearing member, a charging roller 20 serving as the charger, a light irradiator 30 serving as the irradiator, a developing device 40 serving as the developing device, an intermediate transfer medium 50, a cleaning device 60 including a cleaning blade serving as the cleaning device, and a decharging lamp 70 serving as the discharging device.

The developing device 40 includes a black developing unit 45K, a yellow developing unit 45Y, a magenta developing unit 45M, and a cyan developing unit 45C, provided around the photoreceptor 10. The developing units 45K, 45Y, 45M, and 45C include developer containers 42K, 42Y, 42M, and 42C, developer feeding rollers 43K, 43Y, 43M, and 43C, and developing rollers 44K, 44Y, 44M, and 44C, respectively.

The intermediate transfer medium 50 is an endless belt. The intermediate transfer medium 50 is tightly stretched with three rollers 51 to move endlessly in a direction indicated by an arrow. Some of the rollers 51 have a function of applying a transfer bias (i.e., primary transfer bias) to the intermediate transfer medium 50. A cleaning device 90 including a cleaning blade is provided close to the intermediate transfer medium 50. A transfer roller 80 serving as the transfer device is provided facing the intermediate transfer medium 50. The transfer roller 80 is capable of applying a transfer bias to transfer (i.e., secondary transfer) a toner image onto a transfer paper 95. A corona charger 58 configured to charge the toner image on the intermediate transfer medium 50 is provided on a downstream side from a contact point of the photoreceptor 10 with the intermediate transfer medium 50, and a upstream side from a contact point of the intermediate transfer medium 50 with the transfer paper 95, relative to the direction of rotation of the intermediate transfer medium 50.

In the image forming apparatus 100, the photoreceptor 10 is uniformly charged by the charging roller 20, and subsequently the light irradiator 30 irradiates the photoreceptor 10 with a light containing image information to form an electrostatic latent image thereon. The electrostatic latent image formed on the photoreceptor 10 is developed with toners supplied from the developing device 40, to form a toner image. The toner image is transferred onto the intermediate transfer medium 50 due to a bias applied to some of the rollers 51 (i.e., primary transfer), and subsequently transferred onto the transfer paper 95 (i.e., secondary transfer). Toner particles remaining on the photoreceptor 10 are removed by the cleaning device 60, and the photoreceptor 10 is once decharged by the decharging lamp 70.

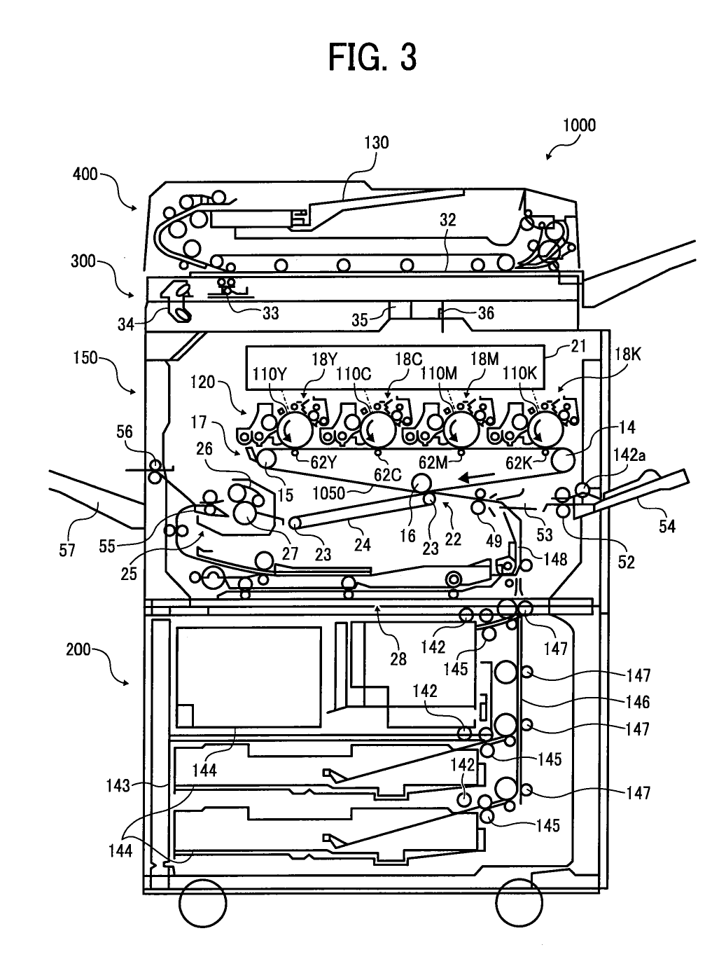

FIG. 3 is a schematic view illustrating another embodiment of the image forming apparatus of the present invention. An image forming apparatus 1000 is a tandem color image forming apparatus. The image forming apparatus 1000 includes a main body 150, a paper feeding table 200, a scanner 300, and an automatic document feeder (ADF) 400.

An intermediate transfer medium 1050 is provided in the center of the main body 150. The intermediate transfer medium 1050, which is an endless belt, is tightly stretched with support rollers 14, 15 and 16, and rotates in a clockwise direction. A cleaning device 17, configured to remove residual toner particles remaining on the intermediate transfer medium 1050, is provided close to the support roller 15. A tandem-type image forming device 120 including image forming units 18Y, 18C, 18M and 18K is provided facing the intermediate transfer medium 1050 so that the image forming units 18Y, 18C, 18M and 18K are arranged in this order around the intermediate transfer medium 1050 relative to the direction of rotation thereof.

A light irradiator 21 is provided close to the tandem-type image forming device 120. A secondary transfer device 22 is provided on the opposite side of the tandem-type image forming device 120 relative to the intermediate transfer medium 1050. The secondary transfer device 22 includes a secondary transfer belt 24, which is an endless belt, tightly stretched with a pair of rollers 23. A sheet of a recording paper fed on the secondary transfer belt 24 contacts the intermediate transfer medium 1050. A fixing device 25 is provided close to the secondary transfer device 22. The fixing device 25 includes a fixing belt 26, which is an endless belt, and a pressing roller 27 configured to press the fixing belt 26.

A reversing device 28 configured to reverse a sheet of the recording paper to form images on both sides thereof is provided close to the secondary transfer device 22 and the fixing device 25.

Next, a procedure for forming a full color image by the image forming apparatus 1000 will be described. An original document is set to a document feeder 130 included in the automatic document feeder (ADF) 400, or placed on a contact glass 32 included in the scanner 300 by lifting up the automatic document feeder 400.

When a start switch button (not shown) is pushed, the scanner 300 starts driving and a first runner 33 and a second runner 34 start moving. When the original document is set to the document feeder 130, the scanner 300 starts driving after the original document is fed on the contact glass 32. When the original document is placed on the contact glass 32, the scanner 300 starts driving immediately after the start switch button is pushed. The original document is irradiated with a light emitted by a light source via the first runner 33, and the light reflected from the original document is then reflected by a mirror included in the second runner 34. The light passes through an imaging lens 35 and is received by a reading sensor 36. Thus, image information of each color is read.

Each color image information is transmitted to the image forming units 18Y, 18C, 18M and 18K, respectively, to form each color toner image.

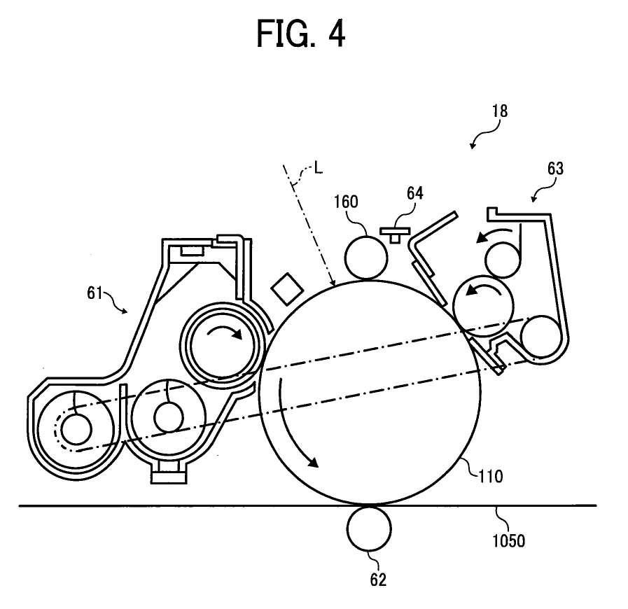

FIG. 4 is a schematic view illustrating an embodiment of the image forming units 18Y, 18C, 18M and 18K. Since the image forming units 18Y, 18C, 18M and 18K have the same configuration, only one image forming unit is illustrated in FIG. 4. Symbols Y, C, M and K, which represent each of the colors, are omitted from the reference number.

The image forming unit 18 includes a photoreceptor 110, a charger 160 configured to uniformly charge the photoreceptor 110, a light irradiator (not shown) configured to irradiate the photoreceptor 110 with a light L containing image information corresponding to color information to form an electrostatic latent image thereon, a developing device 61 configured to develop the electrostatic latent image with a toner to form a toner image thereon, a transfer charger 62 configured to transfer the toner image onto the intermediate transfer medium 1050, a cleaning device 63, and a decharging device 64.

Black, yellow, magenta, and cyan toner images formed on the photoreceptors 110K, 110Y, 110M, 110C, respectively, are independently transferred (i.e., primary transfer) onto the intermediate transfer medium 1050 and superimposed thereon on another so that a full-color toner image is formed.

On the other hand, referring back to FIG. 3, in the paper feeding table 200, a sheet of the recording paper is fed from one of multistage paper feeding cassettes 144, included in a paper bank 143, by rotating one of paper feeding rollers 142. A sheet of the recording paper is separated by separation rollers 145 and fed to a paper feeding path 146. The sheet of the recording paper is fed to a paper feeding path 148, included in the main body 150, by transport rollers 147, and is stopped by a registration roller 49. When a sheet of the recording paper is fed from a manual paper feeder 54 by rotating a paper feeding roller 142a, the sheet is separated by a separation roller 52 to be fed to a manual paper feeding path 53, and is stopped by the registration roller 49. The registration roller 49 is typically grounded, however, a bias can be applied thereto in order to remove paper powder.

The sheet of the recording paper is timely fed to an area formed between the intermediate transfer medium 1050 and the secondary transfer device 22, by rotating the registration roller 49, to meet the full-color toner image formed on the intermediate transfer medium 1050. The full-color toner image is transferred onto the sheet of the recording paper in the secondary transfer device 22 (secondary transfer). Toner particles remaining on the intermediate transfer medium 1050 are removed by the cleaning device 17.

The sheet of the recording paper having the toner image thereon is fed from the secondary transfer device 22 to the fixing device 25. The toner image is fixed on the sheet of the recording paper by application of heat and pressure in the fixing device 25. The sheet of the recording paper is switched by a switch pick 55, ejected by an ejection roller 56, and stacked on an ejection tray 57. When the recording paper is switched by the switch pick 55 to be reversed in the reverse device 28, the sheet of the recording paper is fed to a transfer area again in order to form a toner image on the backside thereof. The sheet of the recording paper having a toner image on the back side thereof is ejected by the ejection roller 56 and stacked on the ejection tray 57.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

In the following descriptions, the volume average particle diameter (Dv) and the ratio (Dv/Dn) of a toner, and the glass transition temperature (Tg), the weight average molecular weight (Mw), and the peak molecular weight of a resin were measured as follows, unless otherwise specified.

### Measurement of Volume Average Particle Diameter (Dv) and Ratio (Dv/Dn) of Toner

Particle diameter distribution of a toner was measured using an instrument COULTER MULTISIZER IIe (from Beckman Coulter K.K.). An interface for outputting the number and volume average particle diameters and a computer were connected to the instrument. The measurement was performed as follows.

(1) 0.1 to 5 ml of a surfactant (an alkylbenzene sulfonate) was included as a dispersant in 100 to 150 ml of an electrolyte (i.e., 1% NaCl aqueous solution including a first grade sodium chloride such as ISOTON-II from Coulter Electrons Inc.);
(2) 2 to 20 mg of a toner was added to the electrolyte and subjected to a dispersion treatment using an ultrasonic dispersing machine for about 1 to 3 minutes to prepare a toner suspension liquid;
(3) the toner suspension liquid was added to 100 to 200 ml of the electrolyte contained in another beaker, so that the resultant toner suspension liquid had a predetermined toner density;
(4) 50,000 particles in the toner suspension liquid were subjected to measurement by the above instrument using an aperture of 100 μm, to determine the volume and number distribution thereof; and
(5) the volume average particle diameter (Dv) and the number average particle diameter (Dn) were determined from the volume and number distributions, respectively.

### Measurement of Glass Transition Temperature (Tg) of Resin

The glass transition temperature of a resin was measured using a TG-DSC system (TAS-100 from Rigaku Corporation).

First, about 10 mg of a sample was contained in an aluminum sample container. The sample container containing the sample was put on a holder unit, and set in an electric furnace. The sample was heated from room temperature to 150° C. at a temperature rising rate of 10° C./min, left for 10 minutes at 1500, cooled to room temperature, and left for 10 minutes. Subsequently, the sample was heated to 150° C. again at a temperature rising rate of 10° C./min in nitrogen atmosphere to obtain DSC curve. The glass transition temperature of the sample was determined from an intersection point of a tangent line and a base line in the DSC curve using an analysis system of the system TAS-100.

### Measurement of Weight Average Molecular Weight (Mw) and Peak Molecular Weight of Resin

The molecular weight distribution of THF-soluble components of a sample was subjected to a measurement under the following conditions.

Instrument: HLC-8120 (from Tohso Corporation)

Column: TSKgel GMHXL x2, TSKgel Multipore HXL-M x1

Preset Temperature: 40° C.

Sample Solution: 0.25% (by weight) THF solution

Injection Volume: 100 μl

Detector: Reflective Index Detector

Standard Substance: Polystyrene

The peak molecular weight is defined as a molecular weight at which the highest peak in the obtained chromatogram is observed.

### Synthesis Example 1

### Synthesis of Intermediate Polyester Resin (1)

In a reaction vessel equipped with a condenser, a stirrer, and a nitrogen inlet pipe, 640 parts of 1,2-propylene glycol, 650 parts of dimethyl terephthalate, 171 parts of adipic acid, and 5 parts of tetrabutoxy titanate serving as a condensation catalyst were contained. The mixture was subjected to a reaction for 8 hours at 170° C. under nitrogen airflow, and subsequently for 4 hours at 225° C. The mixture was further subjected to a reaction under a reduced pressure of from 5 to 20 mmHg, and a reaction product was taken out of the reaction vessel when the softening point thereof became 150° C. The reaction product was cooled and pulverized. Thus, an intermediate polyester resin (1) was prepared.

The intermediate polyester resin (1) had a number average molecular weight (Mn) of 2,200, a weight average molecular weight (Mw) of 8,500, an acid value of 17 mgKOH/g, and a hydroxyl value of 36 mgKOH/g.

### Synthesis Example 2

### Synthesis of Resin (1)

In an autoclave reaction vessel equipped with a thermometer and a stirrer, 130 parts of the intermediate polyester resin (1) prepared above, 50 parts of L-lactide, and 50 parts of D-lactide were contained. Further, 1 part of titanium terephthalate was added thereto. After replacing the atmosphere with nitrogen gas, the mixture was subjected to a reaction for 6 hours at 160° C. Thus, resin (1), serving as the first resin, was prepared.

### Synthesis Example 3

### Synthesis of Resin (2)

The procedure for preparation of the resin (1) was repeated except that the amount of the intermediate polyester resin (1) was changed to 40 parts. Thus, resin (2), serving as the first resin, was prepared.

### Synthesis Examples 4 to 10

### Synthesis of Resins (3) to (9)

In an autoclave reaction vessel equipped with a thermometer and a stirrer, the intermediate polyester resin (1) prepared above, L-lactide, and D-lactide, in amounts described in Table 1, are contained. Further, 1 part of titanium terephthalate is added thereto. After replacing the atmosphere with nitrogen gas, the mixture is subjected to a reaction for 6 hours at 160° C. Thus, resins (3) to (9), serving as the first resin, are prepared.

### Synthesis Example 11

### Synthesis of Resin (10)

The procedure for preparation of the resin (1) was repeated except that the amounts of the L-lactide, D-lactide, and intermediate polyester resin (1) were changed to 65, 35, and 0 parts, respectively. Thus, resin (10), serving as the first resin, was prepared.

The composition, the weight ratio (Y/X) of the block Y to the block X, and the glass transition temperature of each of the resins (1) to (10) are shown in Table 1.

TABLE 1

| | | | Intermediate | | Glass |
|---|---|---|---|---|---|
| | | | Polyester | Weight | Transition |
| | L-lactide | D-lactide | (1) | Ratio | Temperature |
| Resin | (parts) | (parts) | (parts) | (Y/X) | (° C.) |
| (1) | 50 | 50 | 130 | 1.3/1 | 45 |
| (2) | 50 | 50 | 40 | 0.4/1 | 53 |
| (3) | 51 | 49 | 50 | 0.5/1 | 51 |
| (4) | 51 | 49 | 90 | 0.9/1 | 49 |
| (5) | 50 | 50 | 100 | 1/1 | 48 |
| (6) | 50 | 50 | 70 | 0.7/1 | 50 |
| (7) | 50 | 50 | 25 | 0.25/1 | 65 |
| (8) | 50 | 50 | 400 | 4/1 | 38 |
| (9) | 65 | 35 | 50 | 0.5/1 | 55 |
| (10) | 65 | 35 | — | — | 67 |

*) L-lactide is a cyclic compound having two ester bonds per molecule, the ester bond is formed from a dehydration condensation between hydroxyl group of an L-lactic acid and carboxyl group of another L-lactic acid.
**) D-lactide is a cyclic compound having two ester bonds per molecule, the ester bond is formed from a dehydration condensation between hydroxyl group of a D-lactic acid and carboxyl group of another D-lactic acid.

### Synthesis Example 12

### Synthesis of Resin (11)

In a reaction vessel equipped with a condenser, a stirrer, and a nitrogen inlet pipe, 65 parts of ethylene oxide 2 mol adduct of bisphenol A, 90 parts of propylene oxide 3 mol adduct of bisphenol A, 275 parts of terephthalic acid, and 2 parts of dibutyltin oxide were contained. The mixture was subjected to a reaction for 9 hours at 225° C., and subsequently for 5 hours under a reduced pressure of from 10 to 15 mmHg. Thus, a resin (11) was prepared.

The resin (11) had a number average molecular weight (Mn) of 2,300, a weight average molecular weight (Mw) of 6,300, and a glass transition temperature (Tg) of 55° C.

### Example 1

### Preparation of Toner (1)

### (Preparation of Particulate Resin Dispersion)

In a reaction vessel equipped with a stirrer and a thermometer, 680 parts of water, 13 parts of sodium salt of sulfate of ethylene oxide adduct of methacrylic acid (ELEMINOL RS-30 manufactured by Sanyo Chemical Industries, Ltd.), 80 parts of styrene, 80 parts of methacrylic acid, 105 parts of butyl acrylate, and 2 parts of ammonium persulfate were contained, and agitated for 1 hour at 4,200 rpm. Thus, a whitish emulsion was prepared. The emulsion was then heated to 75° C. and subjected to a reaction for 4 hours. Further, 30 parts of a 1% aqueous solution of ammonium persulfate were added thereto, and the mixture was aged for 6 hours at 75° C. Thus, a resin dispersion (1) was prepared.

The resin dispersion (1) was subjected to a measurement using a particle size distribution analyzer LA-920 (from Horiba, Ltd.). Particles in the resin dispersion had a volume average particle diameter of 50 nm. A part of the resin dispersion (1) was dried to isolate the resin, and the isolated resin was subjected to measurements of the glass transition temperature (Tg) and the weight average molecular weight (Mw). The resin had a Tg of 52° C. and an Mw of 120,000.

Next, 780 parts of water, 140 parts of the resin dispersion (1) prepared above, and 80 parts of a 48.5% aqueous solution of dodecyl diphenyl ether sodium disulfonate (ELEMINOL MON-7 manufactured by Sanyo Chemical Industries, Ltd.) were mixed and agitated. Thus, a milky particulate resin dispersion was prepared.

### (Preparation of Aqueous Medium)

To prepare an aqueous medium, 300 parts of ion-exchanged water, 300 parts of the particulate resin dispersion prepared above, and 0.2 parts of sodium dodecylbenzenesulfonate were uniformly mixed and agitated.

### (Preparation of Polyester Prepolymer)

In a reaction vessel equipped with a condenser, a stirrer, and a nitrogen inlet pipe, 680 parts of ethylene oxide 2 mol adduct of bisphenol A, 80 parts of propylene oxide 2 mol adduct of bisphenol A, 282 parts of terephthalic acid, 22 parts of trimellitic anhydride, and 2 parts of dibutyltin oxide were contained. The mixture was subjected to a reaction for 7 hours at 230° C. under normal pressure, and subsequently 5 hours under a reduced pressure of from 10 to 15 mmHg. Thus, an intermediate polyester resin (2) was prepared.

The intermediate polyester resin (2) had a number average molecular weight (Mn) of 2,300, a weight average molecular weight (Mw) of 9,900, a peak molecular weight of 3,100, a glass transition temperature (Tg) of 55° C., an acid value of 0.4 mgKOH/g, and a hydroxyl value of 51 mgKOH/g.

Next, in a reaction vessel equipped with a condenser, a stirrer, and a nitrogen inlet pipe, 395 parts of the intermediate polyester resin (2), 91 parts of isophorone diisocyanate, and 550 parts of ethyl acetate were contained, and reacted for 6 hours at 100° C. Thus, a polyester prepolymer was prepared. The polyester prepolymer included free isocyanates in an amount of 1.47% by weight.

### (Preparation of Master Batch)

First, 1,000 parts of water, 530 parts of a carbon black (PRINTEX® 35 from Degussa) having a DBP oil absorption value of 42 ml/100 g and a pH of 9.5, and 1,200 parts of the resin (11) were mixed using HENSCHEL MIXER (from Mitsui Mining Co., Ltd.). The mixture was kneaded for 30 minutes at 150° C. using a double roll mill, the kneaded mixture was rolled and cooled, and the rolled mixture was pulverized using a pulverizer (from Hosokawa Micron Corporation). Thus, a master batch was prepared.

### (Synthesis of Ketimine Compound)

In a reaction vessel equipped with a stirrer and a thermometer, 30 parts of isophorone diamine and 70 parts of methyl ethyl ketone were contained, and reacted for 5 hours at 50° C. Thus, a ketimine compound was prepared. The ketimine compound had an amine value of 423 mgKOH/g.

### (Preparation of Mother Toner)

In a reaction vessel, 200 parts of the resin (1) serving as the first resin, 30 parts of the polyester prepolymer, and 130 parts of ethyl acetate were contained and agitated, to prepare a resin solution.

Next, 10 parts of a carnauba wax (having a molecular weight of 1,700, an acid value of 2.8 mgLOH/g, and a penetration of 1.6 mm at 40° C.) and 10 parts of the master batch were added thereto. The mixture was subjected to a dispersion treatment using a bead mill (ULTRAVISCOMILL (trademark) from Aimex Co., Ltd.). The dispersing conditions were as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Further, 2.5 parts of the ketimine compound was added thereto. Thus, a toner constituent liquid was prepared.

Next, 150 parts of the aqueous medium was contained in a vessel, and 100 parts of the toner constituent liquid was added thereto while being agitated at 12,000 rpm. The mixture was further mixed for 10 minutes. Thus, an emulsion slurry was prepared. In a conical flask equipped with a stirrer and a thermometer, 100 parts of the emulsion slurry was contained, and subjected to solvent removal for 12 hours at 30° C. while being agitated at a revolution of 20 m/min. Thus, a dispersion slurry was prepared.

Next, 100 parts of the dispersion slurry was filtered under a reduced pressure to obtain a wet cake. The thus obtained wet cake was mixed with 100 parts of ion-exchange water and the mixture was agitated for 10 minutes by a TK HOMOMIXER at a revolution of 12,000 rpm, followed by filtering. Thus, a wet cake (i) was prepared.

The wet cake (i) was mixed with 300 parts of ion-exchange water and the mixture was agitated for 10 minutes with a TK HOMOMIXER at a revolution of 12,000 rpm, followed by filtering. This operation was performed twice. Thus, a wet cake (ii) was prepared.

The wet cake (ii) was mixed with 20 parts of a 10% aqueous solution of sodium hydroxide and the mixture was agitated for 30 minutes with a TK HOMOMIXER at a revolution of 12,000 rpm, followed by filtering under a reduced pressure. Thus, a wet cake (iii) was prepared.

The wet cake (iii) was mixed with 300 parts of ion-exchange water and the mixture was agitated for 10 minutes with a TK HOMOMIXER at a revolution of 12,000 rpm, followed by filtering. This operation was performed twice. Thus, a wet cake (iv) was prepared.

The wet cake (iv) was mixed with 20 parts of a 10% aqueous solution of hydrochloric acid and the mixture was agitated for 10 minutes with a TK HOMOMIXER at a revolution of 12,000 rpm, followed by filtering. Thus, a wet cake (v) was prepared.

The wet cake (v) was mixed with 300 parts of ion-exchange water and the mixture was agitated for 10 minutes with a TK HOMOMIXER at a revolution of 12,000 rpm, followed by filtering. This operation was performed twice. Thus, a wet cake (vi) was prepared.

The wet cake (vi) was dried for 48 hours at 45° C. using a circulating air drier, followed by sieving with a screen having openings of 75 μm. Thus, a mother toner (1) was prepared.

### (Preparation of Toner)

Next, 100 parts of the mother toner (1) and 1.0 part of a hydrophobized silica (H2000 from Clariant Japan K.K.) were mixed for 30 seconds at a revolution of 30 m/sec using HENSCHEL MIXER (from Mitsui Mining Co., Ltd.), followed by pause for 1 minute. This mixing operation was repeated for 5 times. The mixture was sieved with a screen having openings of 35 μm. Thus, a toner (1) was prepared.

### Example 2

### Preparation of Toner (2)

The procedure for preparation of the toner (1) in Example 1 was repeated except that the resin (1) was replaced with the resin (2). Thus, toner (2) was prepared.

### Examples 3 to 12 and Comparative Examples 1 to 3 and 5 to 12

### Preparation of Toners (3) to (15) and (17) to (24)

The procedure for preparation of the toner (1) in Example 1 is repeated except that the first resin is replaced with resins described in Table 2 and an additive KAOWAX EB-FF (from Kao Corporation), which is ethylenebis stearic acid amide, or GEL ALL MD (from New Japan Chemical Co., Ltd), which is bis(p-methylbenzylidene)sorbitol, in an amount described in Table 2 is added. Thus, toners (3) to (15) and (17) to (24) are prepared.

### Comparative Example 4

### Preparation of Toner (16)

The procedure for preparation of the toner (1) in Example 1 was repeated except that the resin (1) was replaced with the resin (10), and 100 parts of the resin (11) were added. Thus, toner (16) was prepared.

The volume and average particle diameters (Dv) and (Dn) and the ratio (Dv/Dn) thereof of each toner are shown in Table 3.

TABLE 2

| | | First Resin | | Second Resin | | Additive | |
|---|---|---|---|---|---|---|---|
| Example | Toner | | Amount | | Amount | | Amount |
| No. | No. | Resin | (parts) | Resin | (parts) | Resin | (parts) |
| Ex. 1 | 1 | 1 | 200 | — | — | — | — |
| Ex. 2 | 2 | 2 | 200 | — | — | — | — |
| Ex. 3 | 3 | 3 | 200 | — | — | — | — |
| Ex. 4 | 4 | 4 | 200 | — | — | — | — |
| Ex. 5 | 5 | 5 | 200 | 11 | 100 | — | — |
| Ex. 6 | 6 | 6 | 200 | 11 | 200 | — | — |
| Ex. 7 | 7 | 1 | 200 | — | — | EB-FF | 2 |
| Ex. 8 | 8 | 2 | 200 | — | — | EB-FF | 1.2 |
| Ex. 9 | 9 | 3 | 200 | — | — | EB-FF | 4 |
| Ex. 10 | 10 | 4 | 200 | — | — | GEL | 2 |
| | | | | | | ALL MD | |
| Ex. 11 | 11 | 5 | 200 | 11 | 100 | GEL | 1.2 |
| | | | | | | ALL MD | |
| Ex. 12 | 12 | 6 | 200 | 11 | 200 | GEL | 4 |
| | | | | | | ALL MD | |
| Comp. | 13 | 7 | 200 | — | — | — | — |
| Ex. 1 | | | | | | | |
| Comp. | 14 | 8 | 200 | — | — | — | — |
| Ex. 2 | | | | | | | |
| Comp. | 15 | 9 | 200 | 11 | 50 | — | — |
| Ex. 3 | | | | | | | |
| Comp. | 16 | 10 | 200 | 11 | 100 | — | — |
| Ex. 4 | | | | | | | |
| Comp. | 17 | 8 | 200 | 11 | 200 | — | — |
| Ex. 5 | | | | | | | |
| Comp. | 18 | 7 | 200 | 11 | 100 | — | — |
| Ex. 6 | | | | | | | |
| Comp. | 19 | 7 | 200 | — | — | EB-FF | 2 |
| Ex. 7 | | | | | | | |
| Comp. | 20 | 8 | 200 | — | — | EB-FF | 0.8 |
| Ex. 8 | | | | | | | |
| Comp. | 21 | 9 | 200 | 11 | 50 | EB-FF | 10 |
| Ex. 9 | | | | | | | |
| Comp. | 22 | 10 | 200 | 11 | 100 | GEL | 2 |
| Ex. 10 | | | | | | ALL MD | |
| Comp. | 23 | 8 | 200 | 11 | 200 | GEL | 0.8 |
| Ex. 11 | | | | | | ALL MD | |
| Comp. | 24 | 7 | 200 | 11 | 100 | GEL | 10 |
| Ex. 12 | | | | | | ALL MD | |

### Preparation of Carrier

To prepare a resin layer coating liquid, 100 parts of toluene, 100 parts of a silicone resin (organo straight silicone), parts of γ-(2-aminoethyl)aminopropyl trimethoxysilane, and 10 parts of a carbon black are mixed for 20 minutes using HOMOMIXER. The resin layer coating liquid is applied to the surfaces of 1,000 parts of spherical magnetite particles having a volume average particle diameter of 50 μm using a fluidized bed coating device. Thus, a carrier is prepared.

### Preparation of Developer

To prepare developers, 5 parts of each of the toners prepared above and 95 parts of the carrier are mixed. Thus, developers corresponding to Examples 11 to 12 and Comparative Examples 11 to 12 are prepared.

### Evaluations

The developers are subjected to the following evaluations of image density and temporal stability thereof, fixability (i.e., maximum and minimum fixable temperature) and change therein, thermostable preservability, temporal stability of charge, and haze. The evaluation results are shown in Tables 3-1 and 3-2.

### (a) Evaluation of Image Density

A solid image including 1.00±0.05 mg/cm² of toner particles is formed on a copying paper TYPE 6000<70W> (manufactured by Ricoh Co., Ltd.) using a tandem color image forming apparatus IMAGIO NEO 450 (manufactured by Ricoh Co., Ltd.). The temperature of the fixing roller is 160±2° C. Any 6 points on the solid image are subjected to a measurement of image density using a spectrometer 938 SPECTRODENSITOMETER (manufactured by X-Rite), and measured values are averaged. The averaged image density is graded as follows.

A: not less than 2.0

B: not less than 1.70 and less than 2.0

C: less than 1.70

### (b) Evaluation of Temporal Stability of Image Density

A solid image including 1.00±0.05 mg/cm² of toner particles is formed on a copying paper TYPE 6000<70W> (manufactured by Ricoh Co., Ltd.) using a tandem color image forming apparatus IMAGIO NEO 450 (manufactured by Ricoh Co., Ltd.), immediately after the developer is supplied, and after the developer is agitated for 600 seconds. The temperature of the fixing roller is 160±2° C. Any 6 points on each of the solid images are subjected to a measurement of image density using a spectrometer 938 SPECTRODENSITOMETER (from X-Rite), and measured values are averaged. The temporal stability of image density is evaluated by comparing the image densities D1 and D2, corresponding to the solid images produced immediately after the developer is supplied, and after the developer is agitated for 600 seconds, respectively, and graded as follows.

A: D2 is not less than 95% of D1.

B: D2 is not less than 85% and less than 95% of D1.

C: D2 is less than 85% of D1.

### (c) Evaluation of Fixability

A solid image including 0.85±0.1 mg/cm² of toner particles is formed on a normal copying paper TYPE 6200 (manufactured by Ricoh Co., Ltd.) and a thick copying paper <135> (manufactured by NBS Ricoh, Co., Ltd.), using a electrophotographic copier MF-200 (manufactured by Ricoh Co., Ltd.) employing a fixing roller using TEFLON®. The copier is modified so that the temperature of the fixing roller is variable. A maximum fixable temperature is defined as a temperature above which hot offset occurs on the normal copying paper. A minimum fixable temperature is defined as a temperature below which the residual rate of image density after rubbing the image on the thick coping paper is less than 70%. The maximum and minimum fixable temperatures are graded as follows.

Maximum fixable temperature:
A: not less than 190° C.
B: not less than 180° C. and less than 190° C.
C: not less than 170° C. and less than 180° C.
D: less than 170° C.

Minimum fixable temperature:
A: less than 135° C.
B: not less than 135° C. and less than 145° C.
C: not less than 145° C. and less than 155° C.
D: less than 155° C.

### (d) Evaluation of Change in Fixability

A 1000-ml vial is filled with a toner, preserved in a constant-temperature chamber at 40° C. for 72 hours, and cooled to 24° C. The toner is treated with HENSHEL MIXER (from Mitsui Mining Co., Ltd.) for 5 seconds at a revolution of 30 m/sec, followed by pause for 10 seconds. This treatment is repeated for 10 times. The toner is then sieved with a mesh having an opening of 35 μm, and set in the electrophotographic copier MF-200 (manufactured by Ricoh Co., Ltd.) employing a fixing roller using TEFLON®, which has been modified so that the temperature of the fixing roller is variable. A solid image including 0.85±0.1 mg/cm² of toner particles is formed on the thick copying paper <135> (manufactured by NBS Ricoh, Co., Ltd.). The minimum fixable temperature, below which the residual rate of image density after rubbing the image on the thick coping paper is less than 70%, is measured, and increment from that measured before the toner has been preserved is measured. The increment is graded as follows. The smaller the increment, the less change in fixability. A toner graded “C” may have a problem in practical use.

A: increment is less than 5° C.

B: increment is not less than 5° C. and less than 10° C.

C: increment is not less than 10° C.

### (e) Evaluation of Thermostable Preservability

A 50-ml glass container is filled with a toner, left in a constant-temperature chamber at 50° C. for 24 hours, and cooled to 24° C. Subsequently, the toner is subjected to a penetration test by a method according to JIS K2235-1991. The penetration (mm) is graded as follows. The greater the penetration (mm), the better the thermostable preservability. A toner having a penetration of less than 5 mm may have a problem in practical use.

A: penetration is not less than 25 mm

B: penetration is not less than 15 mm and less than 25 mm

C: penetration is not less than 5 mm and less than 15 mm

D: penetration is less than 5 mm

### (f) Evaluation of Temporal Stability of Charge

6 g of a developer is contained in a metallic cylinder which could be hermetically-sealed, and agitated at a revolution of 640 rpm. The charge C1 and C2 of the developer, which are measured when the agitation time is 60 and 600 seconds, respectively, by a blow-off method are compared to evaluate temporal stability in charge, and is graded as follows.

A: C2 is not less than 70% of C1

B: C2 is not less than 50% and less than 70% of C1

C: C2 is less than 50% of C1

### (g) Evaluation of Haze

A single-color image is formed on an overhead transparency film PPC-DX (manufactured by Ricoh Co., Ltd.) when the temperature of the fixing belt is set to 160° C. The image is subjected to a measurement of haze (%) using a digital haze computer HGM-2DP (manufactured by Suga Test Instruments Co., Ltd.). The smaller the haze, the better the transparency. The haze is graded as follows.

A: haze is less than 20%

B: haze is not less than 20% and less than 30%

C: haze is not less than 30%

TABLE 3-1

| | | | | Minimum | Maximum | |
|---|---|---|---|---|---|---|
| Example | Dv | Dn | Dv/ | Fixable | Fixable | Change in |
| No. | (μm) | (μm) | Dn | Temperature | Temperature | Fixability |
| Ex. 1 | 5.1 | 4.6 | 1.11 | A | A | B |
| Ex. 2 | 5.5 | 4.7 | 1.17 | B | A | B |
| Ex. 3 | 5.7 | 4.7 | 1.21 | B | A | B |
| Ex. 4 | 4.6 | 4.1 | 1.12 | B | A | A |
| Ex. 5 | 6.2 | 5.3 | 1.17 | A | A | A |
| Ex. 6 | 5.4 | 4.5 | 1.20 | A | B | A |
| Ex. 7 | 5.2 | 4.7 | 1.11 | B | A | A |
| Ex. 8 | 5.7 | 4.8 | 1.19 | B | A | A |
| Ex. 9 | 5.6 | 4.7 | 1.19 | B | A | A |
| Ex. 10 | 4.8 | 4.1 | 1.17 | B | A | A |
| Ex. 11 | 6.1 | 5.1 | 1.20 | A | B | A |
| Ex. 12 | 5.3 | 4.5 | 1.18 | A | B | A |
| Comp. | 5.4 | 4.7 | 1.15 | D | B | B |
| Ex. 1 | | | | | | |
| Comp. | 5.7 | 4.3 | 1.33 | B | D | B |
| Ex. 2 | | | | | | |
| Comp. | 6.3 | 5.1 | 1.24 | C | D | C |
| Ex. 3 | | | | | | |
| Comp. | 5.1 | 4.3 | 1.19 | C | C | C |
| Ex. 4 | | | | | | |
| Comp. | 2.8 | 2.2 | 1.27 | B | D | B |
| Ex. 5 | | | | | | |
| Comp. | 8.4 | 7.5 | 1.12 | B | B | B |
| Ex. 6 | | | | | | |
| Comp. | 5.3 | 4.7 | 1.13 | D | A | A |
| Ex. 7 | | | | | | |
| Comp. | 5.8 | 4.4 | 1.32 | B | D | A |
| Ex. 8 | | | | | | |
| Comp. | 6.2 | 4.9 | 1.27 | C | D | B |
| Ex. 9 | | | | | | |
| Comp. | 5.4 | 4.4 | 1.23 | B | C | B |
| Ex. 10 | | | | | | |
| Comp. | 3.1 | 2.2 | 1.41 | C | D | B |
| Ex. 11 | | | | | | |
| Comp. | 7.5 | 5.1 | 1.47 | C | B | A |
| Ex. 12 | | | | | | |

TABLE 3-2

| | | Temporal | | | |
|---|---|---|---|---|---|
| | | Stability | | Temporal | |
| Example | Image | of Image | Thermostable | Stability | |
| No. | Density | Density | Preservability | of Charge | Haze |
| Ex. 1 | A | A | A | A | A |
| Ex. 2 | A | B | A | B | A |
| Ex. 3 | A | A | A | B | A |
| Ex. 4 | A | B | A | B | A |
| Ex. 5 | A | B | B | A | A |
| Ex. 6 | A | B | B | B | A |
| Ex. 7 | A | A | A | A | A |
| Ex. 8 | B | B | B | A | A |
| Ex. 9 | A | B | A | B | A |
| Ex. 10 | A | A | B | B | A |
| Ex. 11 | A | B | B | A | A |
| Ex. 12 | A | A | B | B | A |
| Comp. | B | B | C | B | B |
| Ex. 1 | | | | | |
| Comp. | A | B | D | C | A |
| Ex. 2 | | | | | |
| Comp. | C | C | C | C | C |
| Ex. 3 | | | | | |
| Comp. | C | C | C | B | C |
| Ex. 4 | | | | | |
| Comp. | B | B | D | B | C |
| Ex. 5 | | | | | |
| Comp. | C | C | C | B | B |
| Ex. 6 | | | | | |
| Comp. | B | B | C | B | B |
| Ex. 7 | | | | | |
| Comp. | B | B | C | B | B |
| Ex. 8 | | | | | |
| Comp. | C | B | D | C | B |
| Ex. 9 | | | | | |
| Comp. | C | C | D | C | C |
| Ex. 10 | | | | | |
| Comp. | B | B | D | B | C |
| Ex. 11 | | | | | |
| Comp. | C | B | C | C | B |
| Ex. 12 | | | | | |

It is apparent from Tables 3-1 to 3-3, the toners of Examples 1 to 12, each of which includes a binder resin including blocks of a racemic mixture of a polylactic acid and a polyester, have good level of maximum and minimum fixable temperatures and thermostable preservability, and produces images with good image density and haze, when the weight ratio (D/L) and the weight ratio (Y/X) are proper.

The toners of Examples 7 to 12, each of which includes a nucleating agent, have good properties without degrading the minimum fixable temperature.

By contrast, the toner of Comparative Example 2, the binder resin of which includes an excessive amount of a polyester resin block, has a low glass transition temperature and maximum fixable temperature and poor thermostable preservability.

Furthermore, the toner of Comparative Example 1, the binder resin of which includes an insufficient amount of a polyester resin block, has a high glass transition temperature and minimum fixable temperature.

The toners of Comparative Examples 3 and 4, the binder resin of each of which includes a first resin including a non-racemic mixture of a D-form compound and an L-form compound, have poor image density and haze. This is because toner constituents are not evenly dispersed in the resultant toner particles.

It is difficult to prepare a toner in Comparative Example 5, because the binder resin includes a polyester resin block and a polyester resin serving as the second resin each in excessive amounts, thereby producing undesired fine particles. Consequently, the toner of Comparative Example 5 has a low maximum fixable temperature and poor thermostable preservability.

The toner of Comparative Example 6 produces a low-density image, because the volume particle diameter (Dv) thereof is too large.

This document claims priority and contains subject matter related to Japanese Patent Applications Nos. 2007-169787 and 2007-169788 both filed on Jun. 27, 2007, 2007-224200 filed on Aug. 30, 2007, and 2008-109174 filed on Apr. 18, 2008, the entire contents of each of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, comprising:
a colorant; and
a binder resin comprising a first resin comprising a block X and a block Y:
wherein block X comprises a resin comprising units formed from a racemic mixture of optically active monomers of a D-form compound and an L-form compound; and
wherein block Y comprises another resin;
wherein a weight ratio of the D-form compound to the L-form compound is from 48/52 to 52/48, and a weight ratio of the block Y to the block X is from 1/3 to 3/1, and
wherein the toner is obtained by dispersing or emulsifying a toner constituent liquid, in which the colorant and the binder resin are dissolved or dispersed in an organic solvent, in an aqueous medium.

2. The toner according to claim 1, wherein the optically active monomers have the following formula (1):
R1-C*—H(—OH)(—COOH) (1)
wherein R1 represents an alkyl group having 1 to 10 carbon atoms.

3. The toner according to claim 1, wherein said another resin of the block Y comprises a polyester resin.

4. The toner according to claim 1, wherein the binder resin further comprises a second resin.

5. The toner according to claim 4, wherein the second resin comprises a polyester resin.

6. The toner according to claim 4, wherein the second resin comprises a polyester resin having a functional group capable of reacting with an active hydrogen group.

7. The toner according to claim 6, wherein the functional group capable of reacting with an active hydrogen group comprises an isocyanate group.

8. The toner according to claim 4, wherein the second resin is obtained by reacting a polyester resin having a functional group capable of reacting with an active hydrogen group with a compound having the active hydrogen group.

9. The toner according to claim 4, wherein the binder resin comprises the second resin in an amount of from 5 to 30% by weight based on a total weight of the binder resin.

10. The toner according to claim 1, wherein the first binder resin has a glass transition temperature of from 40 to 70° C.

11. The toner according to claim 1, further comprising an additive having the following formula (2): 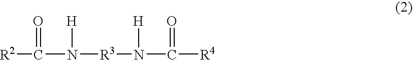
wherein each of R2 and R4 independently represents a saturated or unsaturated straight-chain aliphatic hydrocarbon group having 11 to 21 carbon atoms; and R3 represents an alkylene group having 1 to 6 carbon atoms or a functional group having the following formula:

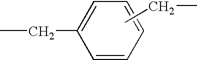

12. The toner according to claim 1, further comprising an additive having the following formula (3): 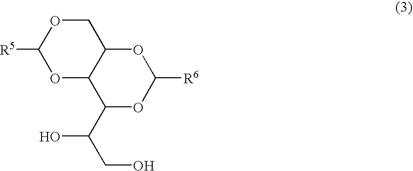
wherein each of R5 and R6 independently represents an alkyl group having 1 to 5 carbon atoms, an alkoxy group having 1 to 5 carbon atoms, or a functional group having the following formula (4) 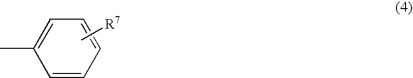
wherein R7 represents a hydrogen atom, a halogen atom, an alkyl group having 1 to 5 carbon atoms, or an alkoxy group having 1 to 5 carbon atoms.

13. The toner according to claim 11, wherein the toner comprises the additive in an amount of from 0.5 to 5 parts by weight based on 100 parts by weight of the first binder resin.

14. The toner according to claim 1, wherein the toner has a volume average particle diameter (Dv) of from 3 to 8 μm, and a ratio of the volume average particle diameter (Dv) to a number average particle diameter (Dn) of from 1.00 to 1.25.

15. A developer, comprising the toner according to claim 1 and a carrier.

16. An image forming apparatus, comprising:
an electrostatic latent image bearing member configured to bear an electrostatic latent image;
an electrostatic latent image forming device configured to form an electrostatic latent image on the electrostatic latent image bearing member;
a developing device configured to develop the electrostatic latent image with the toner according to claim 1 to form a toner image;
a transfer device configured to transfer the toner image onto a recording medium; and
a fixing device configured to fix the toner image on the recording medium.
